(19) United States
(12) Patent Application Publication
(10) Pub. No.: US 2023/0388084 A1
(43) Pub. Date: Nov. 30, 2023

(54) METHODS, TERMINALS, NETWORK EQUIPMENT, SYSTEMS, CIRCUITRY AND COMPUTER PROGRAM PRODUCTS

(71) Applicant: Sony Group Corporation, Tokyo (JP)

(72) Inventors: Shin Horng WONG, Basingstoke (GB); Martin Warwick BEALE, Basingstoke (GB); Yassin Aden AWAD, Basingstoke (GB); Naoki KUSASHIMA, Tokyo (JP)

(73) Assignee: Sony Group Corporation, Tokyo (JP)

(21) Appl. No.: 18/031,913

(22) PCT Filed: Oct. 12, 2021
(86) PCT No.: PCT/EP2021/078182

§ 371 Date: Apr. 14, 2023

(30) Foreign Application Priority Data
Oct. 22, 2020 (EP) 20203468.2

(51) Int. Cl. H04L 5/00; H04L 1/1867; H04L 1/1829

(52) U.S. Cl. CPC H04L 5/0055; H04L 1/1896; H04L 1/1861

(57) ABSTRACT

A method for communicating in a mobile communications network, the network comprising a network equipment configured to provide a wireless interface to communicate with at least a terminal. The method comprises receiving, at the terminal, a grant message scheduling a plurality of downlink resource sets; determining, based on the grant message, that intermediate acknowledgement feedback is to be notified to the base station; making an intermediate attempt to decode the downlink data transmission; and transmitting an indication of the intermediate acknowledgement feedback corresponding to the intermediate attempt to decode the downlink data transmission.

The present application claims the Paris Convention priority of European patent application EP20203468.2, filed 22 Oct. 2020, the contents of which are hereby incorporated by reference.

### FIELD

The present disclosure relates to Methods, terminals, network equipment, systems, circuitry and computer program product, for example for use in mobile communications networks.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communication devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of a desire to support new types of devices with a variety of applications there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay.

The increasing use of different types of network infrastructure equipment and terminal devices associated with different traffic profiles give rise to new challenges for efficiently handling communications in wireless communications systems that need to be addressed.

Example use cases currently considered to be of interest for next and latest generation wireless communication systems include so-called Ultra Reliable and Low Latency Communications (URLLC)/enhanced Ultra Reliable and Low Latency Communications (eURLLC). See, for example, the 3GPP documents RP-160671, “New SID Proposal: Study on New Radio Access Technology,” NTT DOCOMO, RAN#71 [1]; RP-172834, “Work Item on New Radio (NR) Access Technology,” NTT DOCOMO, RAN#78 [2]; RP-182089, “New SID on Physical Layer Enhancements for NR Ultra-Reliable and Low Latency Communication (URLLC),” Huawei, HiSilicon, Nokia, Nokia Shanghai Bell, RAN#81 [3]; and RP-190654, “Physical layer enhancements for NR ultra-reliable and low latency communication (URLLC),” Huawei, HiSilicon, RAN#89, Shenzhen, China, 18 to 21 Mar. 2019 [4].

Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems, in particular to accommodate very different types of communication modes and services.

### SUMMARY

The invention is defined in the independent claims. Further example embodiments are provided in the dependent claims.

According to a first aspect of the present disclosure, there is provided a method for communicating in a mobile communications network, the network comprising a network equipment configured to provide a wireless interface to communicate with at least a terminal. The method comprises receiving, at the terminal, a grant message scheduling a plurality of downlink resource sets, wherein each of the plurality of downlink resource sets is for transmitting a corresponding one of a plurality of repetitions of a downlink data transmission, wherein the grant message further comprises a request for a radio conditions report from the terminal and schedules an intermediate uplink resource set for transmitting the radio conditions report; determining, based on the grant message, that intermediate acknowledgement feedback is to be notified to the base station; making an intermediate attempt to decode the downlink data transmission based on a subset of the plurality of repetitions of the downlink data transmission; and transmitting, using the intermediate uplink resource set, an indication of the intermediate acknowledgement feedback corresponding to the intermediate attempt to decode the downlink data transmission.

According to a second aspect of the present disclosure, there is provided a method for communicating in a mobile communications network, the network comprising a network equipment configured to provide a wireless interface to communicate with at least a terminal The method comprises transmitting, at the network equipment, a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and receiving, using the intermediate uplink resource set, an intermediate acknowledgement feedback notification based on an intermediate attempt to decode the downlink data transmission based on a subset of the plurality of repetitions of the downlink data transmission.

According to a third aspect of the present disclosure, there is provided a terminal for use in a mobile communications network, the network comprising a network equipment configured to provide a wireless interface to communicate with at least the terminal. The terminal is configured to receive a grant message scheduling a plurality of downlink resource sets, wherein each of the plurality of downlink resource sets is for transmitting a corresponding one of a plurality of repetitions of a downlink data transmission, wherein the grant message further comprises a request for a radio conditions report from the terminal and schedules an intermediate uplink resource set for transmitting the radio conditions report; determine, based on the grant message, that intermediate acknowledgement feedback is to be notified to the base station; make an intermediate attempt to decode the downlink data transmission based on a subset of the plurality of repetitions of the downlink data transmission; and transmit, using the intermediate uplink resource set, an indication of the intermediate acknowledgement feedback corresponding to the intermediate attempt to decode the downlink data transmission.

According to a fourth aspect of the present disclosure, there is provided a network equipment for use in a mobile communications network, the network equipment being configured to provide a wireless interface to communicate with at least a terminal of the mobile communications network. The network equipment is further configured to transmit a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and receive, using the intermediate uplink resource set, an intermediate acknowledgement feedback notification based on an intermediate attempt to decode the downlink data transmission based on a subset of the plurality of repetitions of the downlink data transmission.

According to a fifth aspect of the present disclosure, there is provided a system comprising a terminal according to the first aspect above and network equipment according to the second aspect above.

According to a sixth aspect of the present disclosure, there is provided circuitry for a terminal in a mobile communications network, wherein the circuitry comprises a controller element and a transceiver element configured to operate together to connect to the mobile telecommunication network via a wireless interface provided by network equipment of the network. The controller element and the transceiver element are further configured to operate together to receive a grant message scheduling a plurality of downlink resource sets, wherein each of the plurality of downlink resource sets is for transmitting a corresponding one of a plurality of repetitions of a downlink data transmission, wherein the grant message further comprises a request for a radio conditions report from the terminal and schedules an intermediate uplink resource set for transmitting the radio conditions report; determine, based on the grant message, that intermediate acknowledgement feedback is to be notified to the base station; make an intermediate attempt to decode the downlink data transmission based on a subset of the plurality of repetitions of the downlink data transmission; and transmit, using the intermediate uplink resource set, an indication of the intermediate acknowledgement feedback corresponding to the intermediate attempt to decode the downlink data transmission.

According to a seventh aspect of the present disclosure, there is provided circuitry for network equipment in a mobile communications network, wherein the circuitry comprises a controller element and a transceiver element configured to operate together to provide a wireless interface to communicate with at least a terminal of the mobile communications network. The controller element and the transceiver element are further configured to operate together to transmit a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and receive, using the intermediate uplink resource set, an intermediate acknowledgement feedback notification based on an intermediate attempt to decode the downlink data transmission based on a subset of the plurality of repetitions of the downlink data transmission.

According to a eighth aspect of the present disclosure, there is provided a computer program product comprising instructions which, when the program is executed by a computer, cause the computer to carry out the method according to the first or second aspect discussed above.

The network equipment mentioned in the example aspects above may for example be or comprise a base station such as a gNB, a relay node, a transmission and reception point, a remote radio head, etc.

It is to be understood that both the foregoing general description and the following detailed description are illustrative, but are not restrictive, of the present technology. The described example devices, systems or methods of the present disclosure, together with associated teachings, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an example LTE-type wireless telecommunication network;

FIG. 2 schematically represents some aspects of an example new radio (NR) access technology (RAT) wireless telecommunications network;

FIG. 3 schematically represents an example telecommunications system;

FIG. 4 illustrates an example acknowledgement feedback configuration for PDSCH transmissions;

FIG. 5 illustrates another example acknowledgement feedback configuration for PDSCH transmissions;

FIG. 6 illustrates an example acknowledgement for PDSCH aggregation;

FIG. 7 illustrates an example use of aperiodic channel feedback prior to a downlink transmission scheduling;

FIG. 8 illustrates an example use of a single downlink grant for aperiodic channel feedback and downlink transmission scheduling;

FIG. 9 illustrates an example use of a single downlink grant for aperiodic channel feedback and downlink transmission scheduling with downlink data transmission retransmission;

FIG. 10 illustrates an example use of a combined aperiodic channel feedback and acknowledgement feedback associated with a repeated downlink data transmission;

FIG. 11 illustrates an example where repetitions are interrupted following intermediate feedback;

FIG. 12 illustrates an example of notifications of acknowledgement feedback using intermediate and original uplink resources;

FIG. 13 illustrates another example of notifications of acknowledgement feedback using intermediate and original uplink resources;

FIG. 14 illustrates a further example of notifications of acknowledgement feedback using intermediate and original uplink resources;

FIGS. 15 illustrates an example method in accordance with the present disclosure; and

FIGS. 16 illustrates an example method in accordance with the present disclosure.

In the following description, reference is made to the accompanying drawings which illustrate several examples of the present disclosure. It is to be understood that other examples may be implemented and system or method changes may be made without departing from the teachings of the present disclosure. The following detailed description is not to be taken in a limiting sense, and the scope of the present invention is defined only by the claims. It is to be understood that drawings are not necessarily drawn to scale.

### DESCRIPTION OF EXAMPLES

The invention is defined in the appended claims. The present disclosure includes example arrangements falling within the scope of the claims (and other arrangements may also be within the scope of the following claims) and may also include example arrangements that do not necessarily fall within the scope of the claims but which are then useful to understand the teachings and techniques provided herein.

Long Term Evolution Advanced Radio Access Technology (4G)

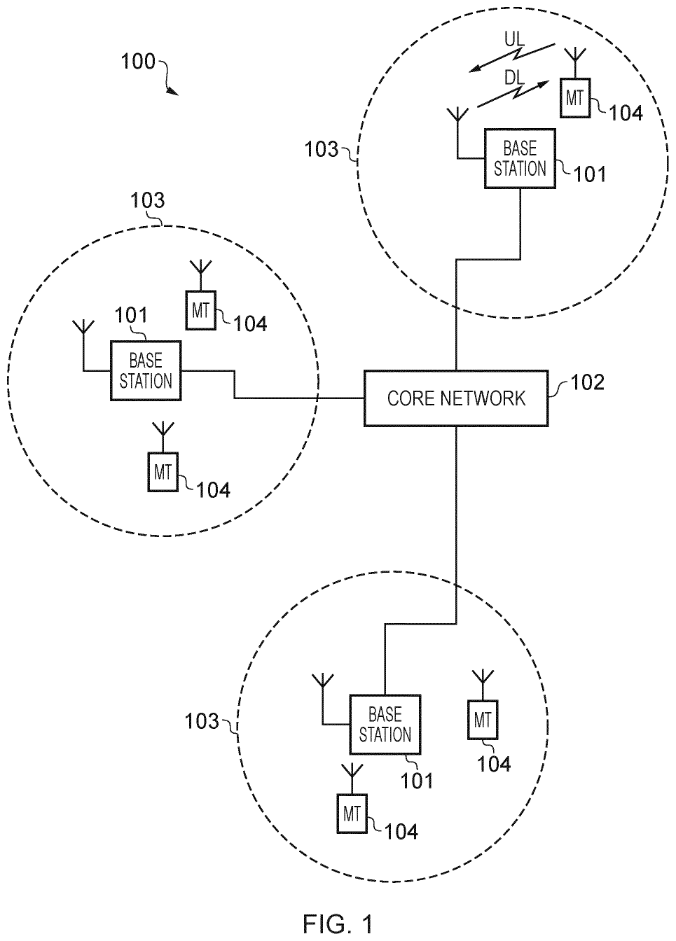

FIG. 1 provides a schematic diagram illustrating some basic functionality of a mobile telecommunications network/system 100 operating generally in accordance with LTE principles, but which may also support other radio access technologies, and which may be adapted to implement examples of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [9]. It will be appreciated that operational aspects of the telecommunications (or simply, communications) networks discussed herein which are not specifically described (for example, in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain examples of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

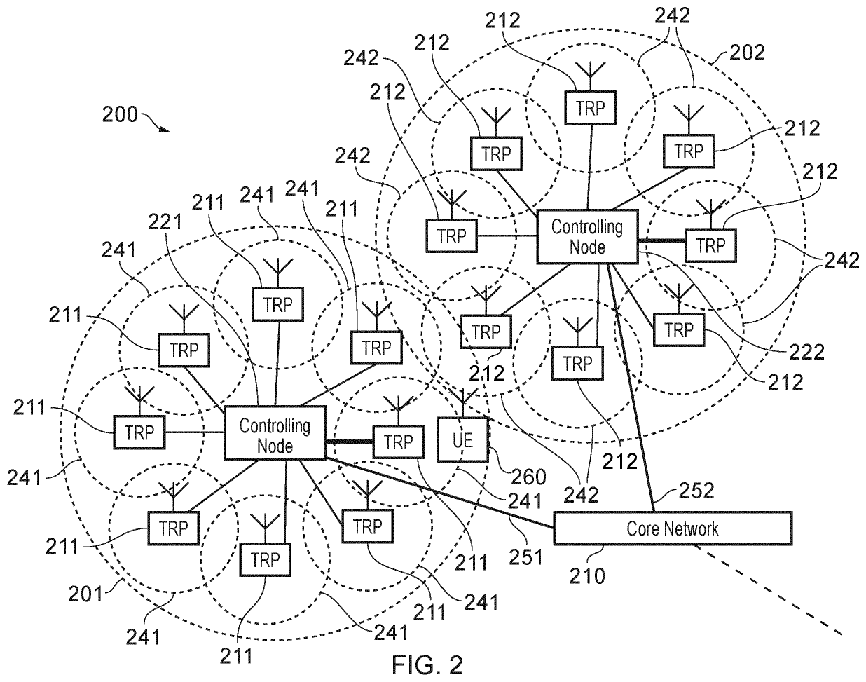

FIG. 2 is a schematic diagram illustrating a network architecture for a new RAT wireless communications network/system 200 based on previously proposed approaches which may also be adapted to provide functionality in accordance with examples of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus examples of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, examples of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

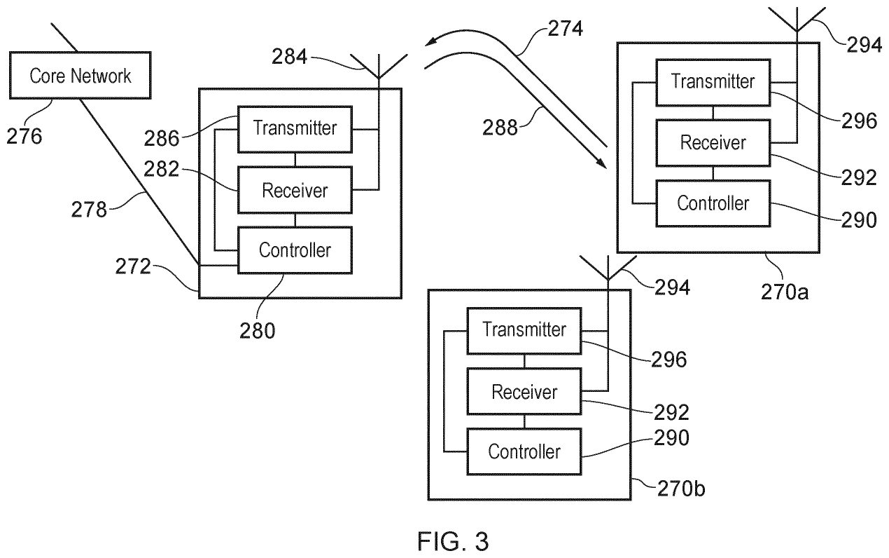

A more detailed illustration of a UE 270 and an example network infrastructure equipment 272, which may be thought of as a gNB 101 or a combination of a controlling node 221 and TRP 211, is presented in FIG. 3. As shown in FIG. 3, the UE 270 is shown to receive downlink data from the infrastructure equipment 272 via resources of a wireless access interface as illustrated generally by an arrow 288 and to transmit uplink data to the infrastructure equipment 272 via resources of a wireless access interface as illustrated generally by an arrow 274. The UE 270 receives the downlink data transmitted by the infrastructure equipment 272 (or sends the uplink data to the infrastructure equipment 272) via communications resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Example Services

As mentioned above, there are a variety of services which may be supported by wireless communications networks. Development of physical layer, radio access and media access protocols and techniques can be adapted to support such services. Example services which are being defined for 5G/New Radio (NR) are the Ultra-Reliable and Low Latency Communications (URLLC) and the enhanced Mobile BroadBand (eMBB) services. URLLC has very low latency and high reliability where a URLLC data packet (e.g. 32 bytes) is required to be transmitted from the radio protocol layer ingress point to the radio protocol layer egress point of the radio interface within 1 ms with a reliability of 99.999% [5] to 99.9999%. On the other hand, eMBB requires high data rate of for example 20 Gbps with moderate latency and reliability (e.g. 99% to 99.9%).

Example developments for 3GPP are eURLLC [6] and NR Unlicensed (NR-U) [8]. For the example of eURLLC, proposals have been made to specify features for high reliability and low latency services such as factory automation, transport industry, electrical power distribution, etc. in a 5G system. Unlicensed radio frequency resources refer to a concept in which the radio resources are not exclusively allocated to a particular operator or radio communications system but are shared between systems, which to some extent compete for these resources. A 3GPP Release-16 NR-U work item specifies features for operation in unlicensed spectrum which includes incorporating Listen Before Talk (LBT) in the NR frame structure to enable NR operation in unlicensed bands. Additional modifications to the eURLLC feature are discussed

in a new Release 17 Work Item where one of the objectives is to enhance HARQ-ACK and CSI feedbacks for PDSCH transmissions.

It will be appreciated that while the present teachings and techniques (in this section but also in the entire disclosure) are illustrated referring to PDSCHs, PUCCHs, DCIS, HARQ-ACKs, URLLC, etc., this is only for illustrative purposes and these teachings and techniques are equally applicable to arrangements using different configurations for downlink transmission resources, uplink transmissions resources, downlink grant information, acknowledgement feedbacks, low latency and/or high reliability communications, etc., respectively.

### PDSCH HARQ-ACK Feedbacks

In some current systems, a Dynamic Grant PDSCH (DG-PDSCH) can be used where the PDSCH resource (or set of resources) is dynamically indicated by the gNB using a DL Grant carried by a DCI in a PDCCH.

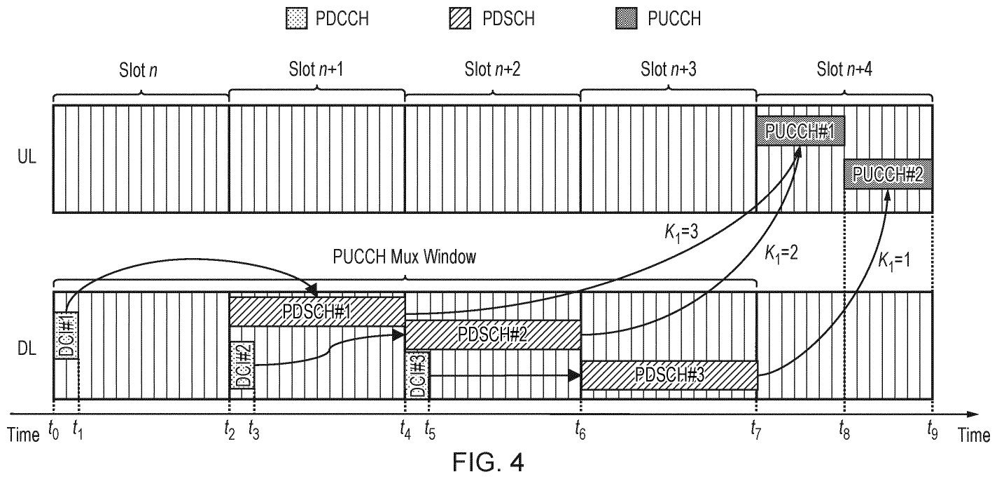

PDSCH (Physical Downlink Shared Channel) transmissions are associated with acknowledgement or acknowledgement feedback transmissions, namely HARQ transmissions in this case. FIG. 4 illustrates an example acknowledgement feedback configuration for PDSCH transmissions, for example according to a Release 15 configuration. It will be appreciated that while the illustration of FIG. 4 is based on current arrangements, the teachings of the present disclosure are not limited to these current arrangements and are applicable to other systems.

Currently, for a PDSCH ending in slot n, the corresponding uplink resources (in this case a PUCCH) for carrying the acknowledgement feedback (e.g. HARQ-ACK) are scheduled in slot n+K₁. In Dynamic Grant PDSCH, the value of parameter K₁ is indicated in a field called “PDSCH-to-HARQ_feedback timing indicator”. This field is provided in the Downlink grant for the PDSCH to which the acknowledgement feedback relates to. This is currently carried by the Downlink Control Information (DCI) associated with the PDSCH and this parameter can for example be carried by DCI Format 1_0, DCI Format 1_1 or DCI Format 1_2. In FIG. 4, PDSCH#1 is configured with K₁=3 and is transmitted in slot n+1, such that the acknowledgement feedback is set in slot n+4.

Multiple PDSCHs can point to the same slot and/or to the same uplink resources for transmission of their respective acknowledgement feedbacks (e.g. HARQ-ACKs) and these acknowledgement feedbacks can then be multiplexed into a single set of uplink resources, such as a PUCCH if they are for PDSCHs for the same UE. Hence, a PUCCH can contain multiple HARQ-ACKs for multiple PDSCHs. In the example of FIG. 4, three downlink grants are transmitted to the UE via DCI#1, DCI#2 and DCI#3 in slot n, n+1 and n+2 respectively. DCI#1, DCI#2 and DCI#3 schedule PDSCH#1 in slot n+1, PDSCH#2 in slot n+2 and PDSCH#3 in slot n+3 respectively. DCI#1, DCI#2 and DCI#3 further indicate K₁=3, K₁=2 and K₁=1 respectively. Since the K₁ values indicate that the HARQ-ACK feedbacks for PDSCH#1, PDSCH#2 and PDSCH#3 are all transmitted in slot n+4, the UE can then multiplex these multiple acknowledgement feedbacks into the single PUCCH in slot n+4. In some cases, as illustrated in FIG. 4, the K₁ for the PDSCHs can all point to the same slot (e.g. slot n+4 in FIG. 4) but the PDSCHs may be associated with different uplink resources (e.g. PUCCH#1 and PUCCH#2 in FIG. 4). It should be noted that in cases where multiple PUCCHs resources are provided, the UE can select one of these PUCCH for transmitting acknowledgement feedbacks and multiplex the feedbacks in a single PUCCH as appropriate. For example, in FIG. 4, the acknowledgement feedbacks for PDSCH#1, PDSCH#2 and PDSCH#3 can be transmitted in PUCCH#2. This is discussed in more detail below.

It will be appreciated that such multiplexing techniques are not limited to acknowledgement feedback and may be used for example to multiplex any combination of two or more of: acknowledgement feedback(s); other types of Uplink Control Information (UCI) such as Scheduling Request (SR) and any other appropriate uplink data or transmission.

In this context, the concept of a PUCCH Multiplexing Window is used where this is defined relative to a PUCCH. This refers to a time window prior to the PUCCH, where PDSCHs can be transmitted and their acknowledgement feedbacks multiplexed into that PUCCH. The size of the PUCCH Multiplexing Window depends on the range of values Ki can take for that PUCCH. For example, in the illustration of FIG. 4, the maximum K₁ value is 4 slots, which means the PUCCH Multiplexing Window is from Slot n to Slot n+3. In this example configuration, the PUCCH Multiplexing Window refers to the slots in which the PDSCHs are transmitted as the K₁ value is with defined with respect to the PDSCH and its associated slot(s). If for example a PDSCH#0 is transmitted in slot n with a DCI#0 transmitted in a previous slot, the acknowledgement feedback for PDSCH#0 can be multiplexed with the acknowledgement feedback for PDSCH#1-PDSCH#3.

In Release 15, only one PUCCH per slot is allowed to carry acknowledgement feedbacks (e.g. HARQ-ACKs) for the same UE even if the different PUCCHs do not overlap in time (e.g. PUCCH#1 and PUCCH#2 in FIG. 4—in this release the UE would not be able to use both PUCCH#1 and PUCCH#2). The uplink resource or set of resources for acknowledgement feedbacks (e.g. PUCCH resource in FIG. 4) is indicated on the downlink. In this example, it is indicated in the “PUCCH Resource Indicator” (PRI) field in the DL Grant (e.g. DCI#1-3). Each DL Grant may indicate a different PUCCH resource for the corresponding acknowledgement feedback. In this case and in order to determine which PUCCH to use, the UE will use the PRI indicated in the last DL Grant, which is expected to be associated with the last PDSCH of the PUCCH Multiplexing Window. It will be appreciated that the terminal may use the PUCCH resource associated with the last DL Grant for a PDSCH in a Multiplexing Window, the last PDSCH of the Multiplexing Window and more generally based on any other suitable PUCCH resource selection process based on the DL Grants and/or DL data transmissions in the Multiplexing Window. After the last PDSCH is received, the UE will know the total number of HARQ-ACK bits to transmit and which acknowledgement feedbacks to send. In the example in FIG. 4, DCI#1 and DCI#2 indicate PUCCH#1 for the HARQ-ACK transmissions and DCI#3 indicates PUCCH#2, where PUCCH#1 and PUCCH#2 do not overlap in time. Since DCI#3 is the last DL Grant that schedules the last PDSCH, i.e. PDSCH#3, in the Multiplexing Window, the UE will use PUCCH#2 to carry the HARQ-ACK for all of PDSCH#1, PDSCH#2 and PDSCH#3. It should be noted that in this discussion, the UE can use only one PUCCH for acknowledgement feedbacks but it may send another PUCCH in the same slot for other control information transmissions (e.g. other UCI such as Scheduling Request “SR”), if the PUCCHs do not overlap in time.

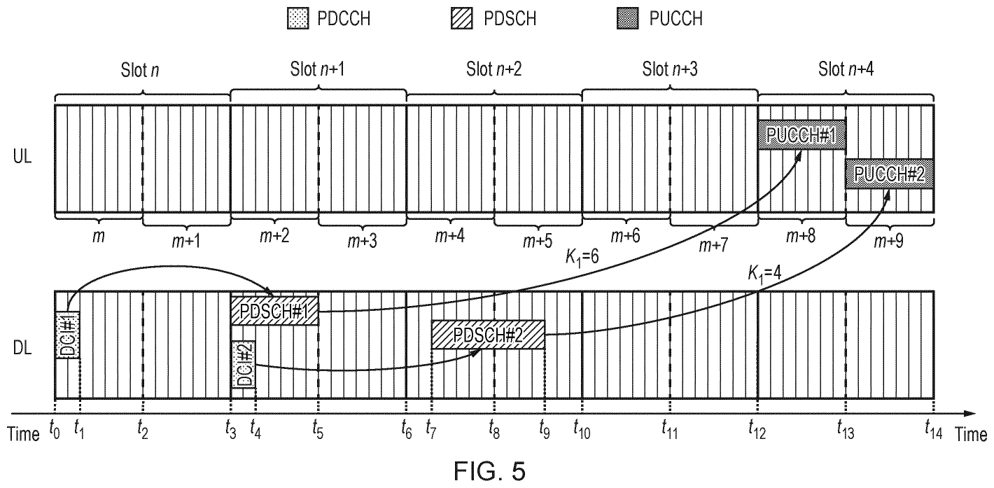

In Release 16 eURLLC, sub-slot PUCCH have been introduced where a sub-slot based PUCCH configuration or system allows more than one PUCCH carrying acknowledgement feedbacks to be transmitted within a slot. An example is illustrated in FIG. 5 which illustrates another example acknowledgement feedback configuration for PDSCH transmissions.

Sub-slot PUCCHs have been introduced for carrying HARQ-ACK for URLLC PDSCH. This gives more opportunities for PUCCH carrying HARQ-ACKs for PDSCHs to be transmitted within a slot, thereby reducing latency for HARQ-ACK feedbacks. In a sub-slot based PUCCH system, the granularity of the Ki parameter (i.e. the time difference between the end of PDSCH and the start of its corresponding PUCCH) is in units of sub-slot instead of slot, where the sub-slot size can be 2 symbols or 7 symbols. In the example of FIG. 5, the sub-slot size is seven symbols (i.e. half a slot which is fourteen symbols) and the sub-slots are labelled as m, m+1, m+2, . . . In this example:
PDSCH#1 is transmitted in slot n+1 and looking at the sub-slot numbering used for sub-slot based HARQ-ACK PUCCHs, it is also transmitted in sub-slot m+2. This example PDSCH being associated with or configured with K₁=6, the corresponding acknowledgement feedback (HARQ-ACK) will be transmitted in sub-slot m+2+K₁=m+8.
PDSCH#2 is transmitted in slot n+2 but occupies both sub-slots m+4 and m+5. The DL Grant in DCI#2 that schedules PDSCH#2 indicates K₁=4. In current systems, the parameter K₁ defines a number of sub-slots relative to the sub-slot where the PDSCH ends, Accordingly and with an indicator K₁=4 associated with PDSCH#2 ending in sub-slot m+5, this schedules a PUCCH for the associated HARQ-ACK at sub-slot m+5+K₁=m+9.

These techniques can generally be viewed as associating a parameter (e.g. K₁) with a downlink transmission (e.g. PDSCH) for determining a set of one or more uplink resources (e.g. PUCCH) for transmitting acknowledgement feedback information (e.g. HARQ-ACK) associated with the downlink transmission. In some cases, the parameter (e.g. K₁) is sent as downlink control information, for example as part of or in conjunction with a downlink grant or downlink grant message (e.g. a DL grant in a DCI).

### PDSCH Aggregation

In some cases, a PDSCH transmission may be repeated using a technique called PDSCH Aggregation. In such a case, the PDSCH can be repeated at the slot level and each repetition starts in the same symbol offset from the slot boundary. It will be appreciated that while it is expected that the current agreed configuration for PDSCH aggregation with the same resources being used in different slots is likely to be found optimal in many cases, in other cases the repetitions may be transmitted with different time or frequency offsets or configurations within each slot—and they may also not be transmitted in every consecutive slot. The techniques discussed herein can be applied equally to such other arrangements.

In existing systems, an aggregation factor which identifies a number of repetitions is configured using the RRC parameter “pdsch-AggregationFactor”, where the parameter is selected from one or more predetermined values, such as 2, 4 or 8. If the parameter “pdsch-AggregationFactor” is not configured then no repetition is applied. Currently a repetition configuration for a terminal is applied to all PDSCH in a Bandwidth Part (associated with the RRC signalling) but it will be appreciated that the teachings provided herein can apply regardless of how the repetition has been configured, for example using RRC signalling as currently used, using dynamic configurations (e.g. per PDSCH), etc.

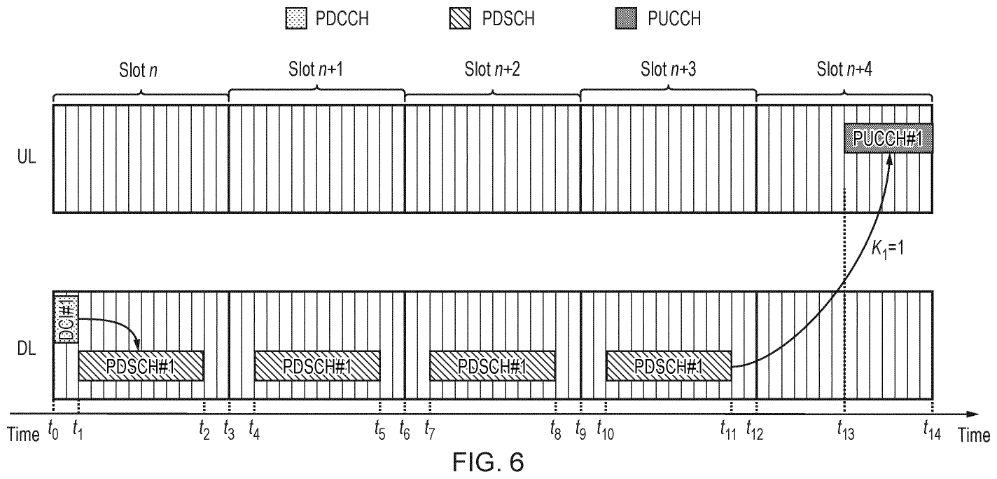

FIG. 6 illustrates an example acknowledgement for PDSCH aggregation where the aggregation parameter is set to four. In this example, DCI#1 schedules PDSCH#1 that is configured with 4× repetition (Aggregation Factor=4). In this example, each PDSCH repetition is transmitted at the same symbol offset (S=2 symbols) and duration (L=10 symbols) in four consecutive slots and the PDSCH is associated with K₁=1. As the last repetition is transmitted in Slot n+3, the HARQ-ACK for PDSCH#1 is transmitted in the uplink at Slot n+4, namely in PUCCH#1.

### CSI Feedback

A link adaptation scheme can be applied to the downlink transmissions such as PDSCH transmissions. For example, in NR an Adaptive Modulation and Coding (AMC) can be applied to the PDSCH, where the AMC can use various modulation schemes and/or channel coding rates.

The use of a modulation and/or coding scheme is often associated with radio conditions estimations or assessments (e.g. channel conditions or state information) with a view to selecting a scheme where the modulation and/or coding scheme can be selected to suit the radio conditions for the terminal. In NR, for channel state estimation purposes, the UE may be configured to measure Channel State Information Reference Signals (CSI-RS) and estimate the downlink channel state based on the CSI-RS measurements. The UE can then inform the base station (e.g. gNB) of the estimated channel state, for example for the gNB to use in link adaptation, e.g. in a modulation and/or coding scheme selection. The reporting may rely on CSI report (sometimes also referred to simply as “CSI”) reporting on the measurement of the CSI-RS.

In a legacy system, the Channel State Information (CSI) reporting to the base station can be configured to be periodic, aperiodic or semi-persistent:
Periodic CSI: CSI information is transmitted (e.g. using PUCCH) periodically. Accordingly, the base station receives a CSI report periodically. Additionally, the periodic CSI can be also transmitted using PUSCH resources when a PUSCH (e.g. that is scheduled to transmit uplink data such as UL-SCH data) collides or overlaps in time with the PUCCH.
Aperiodic CSI (A-CSI): the report is sent on request and can thus be seen as an on-request report. In existing systems, an A-CSI report is transmitted using PUSCH resources and is triggered by a “CSI Request” field in the UL Grant associated with the PUSCH. In A-CSI, upon request from the base station, the terminal will send only a single CSI report in response. It will be appreciated that the same techniques may be applied where a predetermined number of A-CSI reports may be sent. Accordingly, the UE does not normally send reports, it only does so on request and when it receives a request, it will send a predetermined finite number of reports.
Semi-persistent CSI: the CSI report is sent periodically once it is activated by the base station and is stopped when deactivated by the base station. The activation and de-activation can for example be signalled by DCI or MAC CE signalling. Accordingly, once activated, the UE will start transmitting reports until the reporting is deactivated and will not know in advance the number of reports it might send in the reporting session (between activation and de-activation). Semi-persistent CSI reports may be configured to transmit using PUSCH resources or PUCCH resources. In existing systems, semi-persistent CSI on PUSCH resources is activated and deactivated by DCI signalling and semi-persistent CSI on PUCCH resources is activated and deactivated by MAC CE—although it will be appreciated that other configuration methods may be used.

In existing arrangements, the CSI usually contains various information such as one or more of: a Precoding Matrix Indicator (PMI), a Rank Indicator (RI), a Layer Indicator (LI), a CSI-RS Resource indicator (CRI), an SS/PBCH Block Resource indicator (SSBRI) and a Channel Quality Indicator (CQI). The channel quality information (e.g. CQI) may then be used by the base station for selecting an appropriate Modulation & Coding Scheme (MCS). It is left to the base station how to select an MCS which is deemed appropriate based in the reporting from the terminal.

It will be appreciated that, for the base station, it is usually assumed that an up-to-date CSI report (containing CQI) will help the base station select a more accurate or adapted MCS when scheduling a PDSCH. On the other hand, the reporting is using resources which may be considered undesirable in some circumstances, such as when the downlink traffic is sporadic. For example, while the base station could possibly configure a periodic CSI report to be sent very often, this is likely to lead to inefficient use of uplink resources in many cases. In some cases (e.g. with sporadic traffic), it may be considered more appropriate for the base station to trigger an A-CSI from the UE to report an up-to-date CQI prior to a potential (e.g. possible, likely or expected) PDSCH scheduling instance.

A-CSI Feedback scheduling challenges

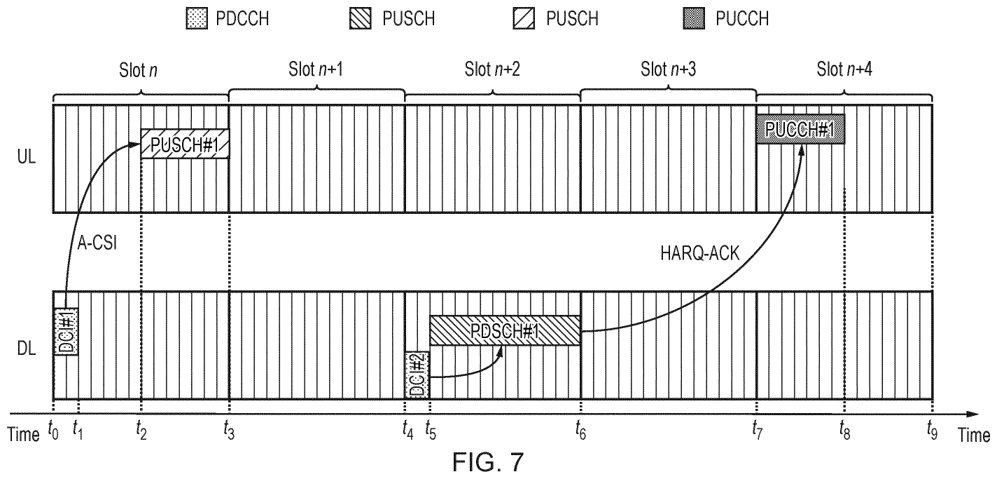

FIG. 7 illustrates an example use of aperiodic channel feedback prior to scheduling a downlink transmission. In this example, the base station wishes to send a PDSCH to the terminal and determines that it would be appropriate to obtain an up-to-date CSI from the terminal prior to sending the downlink data, e.g. for selecting an appropriate modulation and/or coding scheme for the downlink data transmission. Accordingly, the gNB sends DCI#1 carrying an UL Grant (scheduling PUSCH#1 to carry the CSI report) with a CSI Request. The CSI request is for triggering an A-CSI report from the UE. At time t₄, the gNB then sends DCI#2 carrying a DL Grant scheduling PDSCH#1, where the base station can select an MCS for PDSCH#1 based on the A-CSI report provided by the UE in PUSCH#1.

It will however be appreciated that scheduling the A-CSI and PDSCH as illustrated in FIG. 7 can cause some delay as the base station needs to wait for the CSI report to arrive and to be processed before it can send the downlink transmission.

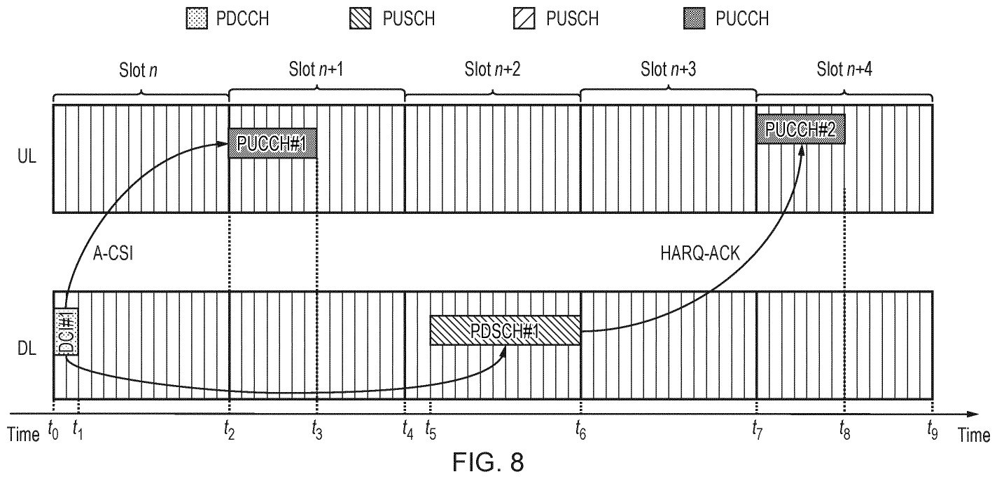

It has thus been suggested (see for example in reference [11]) to use a DL Grant to trigger the A-CSI report. In such an arrangement, instead of using an UL Grant for a PUSCH for the A-CSI, the DL grant can also schedule a PUCCH for carrying the A-CSI. As the A-CSI report is requested for scheduling PDSCHs, using a single grant rather than separate grants (a UL Grant to schedule PUSCH resource for the A-CSI and a DL Grant for the PDSCH) reduces the PDCCH overhead. This is illustrated in FIG. 8 which provides an example use of a single downlink grant for aperiodic channel feedback and downlink transmission scheduling.

As shown in FIG. 8, a single DCI DCI#1 schedules both a PUCCH#1 on the uplink and a PDSCH#1 on the downlink (associated with another PUCCH, PUCCH#2, for transmitting the acknowledgement feedback). As the UE may not have any uplink data to be transmitted on the PUSCH that is triggered for the A-CSI, using a PUSCH may not be an efficient use of uplink resources. In this example, it is suggested that the PUCCH resource for A-CSI (PUCCH#1) is indicated in the DL Grant, which is a separate PUCCH resource to that used for PDSCH HARQ-ACK feedback. In some other examples, the PUCCH resource may be the same resource as that used for PDSCH HARQ-ACK feedback.

While this reduces the signalling overhead, there is an associated limitation in that the A-CSI is not suitable for use for the first PDSCH transmission. This is because the resources for the first PDSCH have already been scheduled by the DL Grant DCI#1 before the A-CSI report is even received by the gNB. Accordingly, the base station cannot make use of the A-CSI for scheduling of the first PDSCH of the UE transmitting the A-CSI. The PDSCH is thus scheduled using a modulation and/or coding scheme which is selected before the A-CSI is sent and therefore without using the A-CSI report. This has been noted for example in reference [12].

Looking at FIG. 8 again, even if the A-CSI is carried by a separate PUCCH (e.g. PUCCH#1), different from the one used for HARQ-ACK feedback (e.g. PUCCH#2) and even if PUCCH#1 is transmitted prior to the PDSCH#1, the resources for PDSCH#1 have already been scheduled in DCI#1, where the resources to schedule will depend on the MCS selected for PDSCH#1. Accordingly, the A-CSI report cannot be used for PDSCH#1, even if it is transmitted prior to PDSCH#1. In another example, if the A-CSI report is carried in the same uplink resources as the HARQ-ACK (e.g. PUCCH#2), then it is also too late for the A-CSI report to be used for PDSCH#1.

With this in mind, and appreciating that a DL Grant triggering A-CSI results in an A-CSI report which cannot be used for the first PDSCH, it has been suggested that that A-CSI report may be used for PDSCH retransmissions.

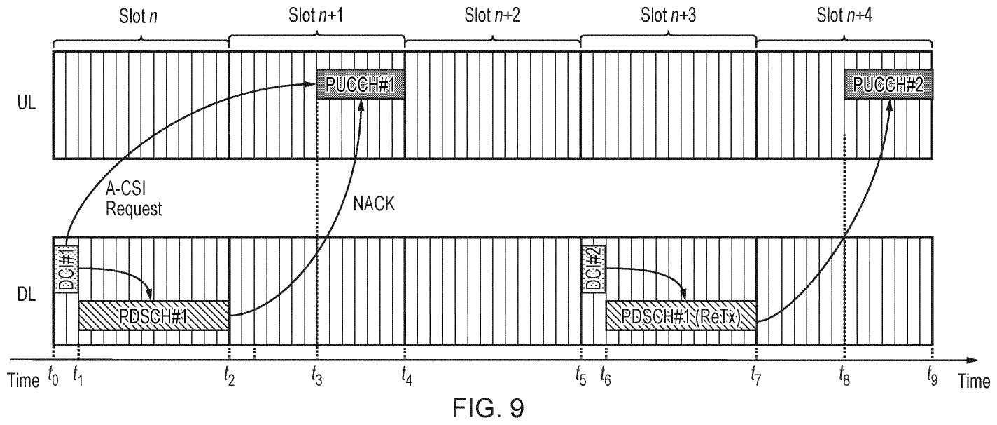

FIG. 9 illustrates an example use of a single downlink grant for aperiodic channel feedback and downlink transmission scheduling with downlink data transmission retransmission. In this example DCI#1 is a DL Grant that schedules PDSCH#1 and PUCCH#1 for the HARQ-ACK feedback for PDSCH#1. DCI#1 also triggers an A-CSI, which is transmitted in PUCCH#1 together with the HARQ-ACK feedback. In this example, the UE fails to decode PDSCH#1 and sends a NACK in PUCCH#1 back to the gNB, alongside the requested aperiodic report. The gNB can then use the information provided by the A-CSI in PUCCH#1 to schedule the retransmission of PDSCH#1 at time t₆ to t₇. The scheduling for the retransmission is signalled using the DL Grant in DCI#2. Accordingly, in this case the A-CSI sent in PUCCH#1 can benefit the PDSCH retransmission. While this can then be beneficial, this is also balanced with the fact that PDSCH retransmissions are relatively rare, especially for URLLC transmissions as URLLC transmissions are expected to have good reliability performance. Accordingly, in most cases the A-CSI reporting would merely increase the load of the PUCCH carrying HARQ-ACK while providing a limited benefit to the downlink transmissions. This has also been noted in reference [12].

It is also noted that, in addition to using DL Grant triggered A-CSI for PDSCH retransmissions, it could also be used for PDSCH Aggregation. For example, after the first PDSCH transmission (e.g. the first repetition of all repetitions), the gNB may be able to make use of the information in the A-CSI report to adjust subsequent PDSCH repetition resources, for example by adjusting the power for the repetitions (see for example reference [13]).

While the aperiodic report may be used to improve the transmissions for the repeated PDSCH, further improvements can also be made when using aperiodic channel information reporting and PDSCH repetition, for example with a view to improving the use of resources.

Combined A-CSI and HARQ-ACK feedback

According to the present disclosure, there is provided an arrangement where, when a repeated downlink transmission is scheduled by a downlink grant and when the downlink grant also schedules uplink resources for transmitting a radio condition report (e.g. channel quality report or indicator, channel state report or indicator, etc.), the terminal can use the uplink resources to transmit an intermediate acknowledgement feedback message for a partial decoding attempt of the repeated transmissions. From one perspective, the terminal can be said to provide a fast acknowledgement feedback.

The radio condition report can for example be a report based on an aperiodic channel feedback (or channel quality) scheme.

Accordingly, if the intermediate decoding attempt is successful, the transmission of the repetitions can be stopped, and the resources can be released for other transmissions. If the intermediate decoding attempt is unsuccessful (which may for example lead to a negative acknowledgement feedback message being sent or to no acknowledgement feedback message being sent), the repetitions may carry on. If appropriate, the remainder of the transmissions may also be adjusted accordingly, for example based on the requested radio condition report transmitted in the uplink resources (see for example reference [13]) and the report may be used for the purpose for which it was scheduled in the first place.

Accordingly, the overhead compared to not sending any intermediate feedback is minimal (the uplink resources are scheduled for the report regardless, with the trade-off being an additional transmission of an acknowledgement message) while the potential benefit for the remainder of the repeated transmissions is much greater, especially in cases where the acknowledgement feedback is a positive one and where unnecessary transmissions can be interrupted and resources can be made available for other transmissions.

For example, in some cases the intermediate acknowledgement feedback message may relate to all repeated transmissions in the slots before and up to the slot of the uplink resources, or all repeated transmissions in the slots before and up to the slot before the slot of the uplink resources. It will be appreciated that the reference to slots is illustrative and that the same teachings apply equally to other time units, e.g. sub-slots, groups of a predetermined number of symbols, time period, etc.

If the intermediate decoding attempt is unsuccessful, a further acknowledgement feedback message may be sent for a larger subset of the repetitions or for all of the repetitions of the downlink transmission indicating whether the corresponding further decoding attempt was unsuccessful or successful. In a case where only one intermediate feedback message may be sent, a positive one can stop the remainder of the repetitions and a negative one (or no acknowledgement feedback message being sent) may mean that the next feedback opportunity would be for a final acknowledgement feedback message. Such a final message may for example correspond to a message conventionally expected as a notification of whether the decoding of the repeated PDSCH was successful or not, at the end of the repeated transmissions.

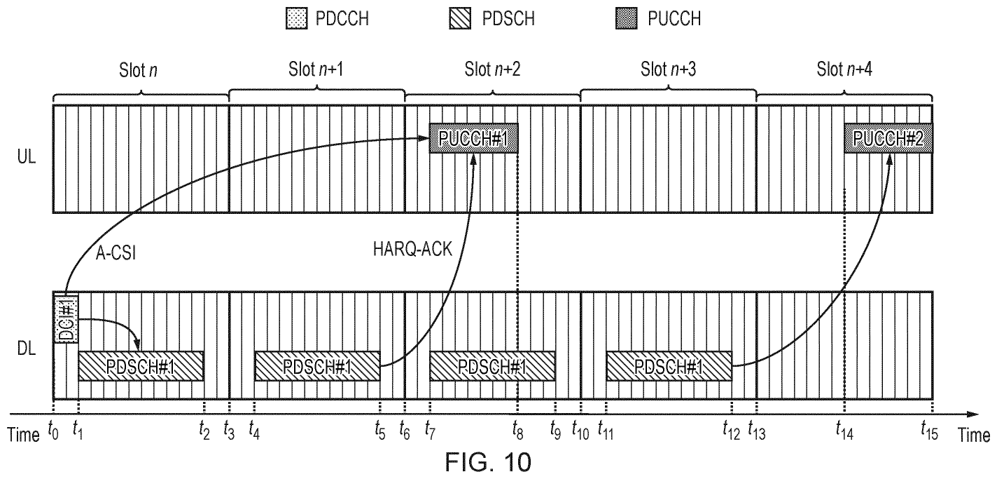

FIG. 10 illustrates an example use of a combined aperiodic channel feedback and acknowledgement feedback associated with a repeated downlink data transmission. According to the teachings discussed above, HARQ-ACK feedback resources are provided for in a DL Grant triggering A-CSI before the PDSCH repetition ends. More specifically in this example, DL Grant DCI#1 schedules PDSCH#1 that is configured with a PDSCH Aggregation scheme configured with four repetitions. DCI#1 also triggers or requests an A-CSI which is carried by PUCCH#1 scheduled (also by DCI#1) in Slot n+2, after the 2n d PDSCH repetition. According to the techniques provided herein, a HARQ-ACK may be transmitted in PUCCH#1 after the UE has attempted to decode PDSCH#1 with 2 repetitions, i.e. the repetitions in Slots n and n+1 before the slot of PUCCH#1.

The combined acknowledgement feedback and radio conditions report may be used in different ways such as according to one or more of the following techniques:
If the UE transmits a NACK (negative feedback) in PUCCH#1, the gNB can use it in conjunction with the A-CSI for the remainder of the repetitions, for example to adjust an Outer Loop Link Adaptation (e.g. to adjust the power of the repeated downlink transmissions). Accordingly, the A-CSI may then be used by the scheduler to improve the communication configuration with the UE.
   From one perspective, such a NACK can be seen as being used as an implicit indication to review the configuration for the remainder of the downlink transmissions in view of the (A-)CSI. Viewed differently, a NACK may be seen as a notification that the terminal was not able to decode and send an ACK (positive feedback) in the uplink resources, and this can be treated as an indication that the scheduler would benefit from using the A-CSI to configure or re-configure the remainder of the repetitions.
If the UE transmits an ACK (positive feedback) in PUCCH#1, the gNB can terminate the remaining PDSCH#1 repetitions to save resources. This will improve efficiency of the network and reduce latency in the communication as other downlink transmissions (e.g. another Transport Block “TB”) may be sent to the UE. It will be appreciated that the decision on what to schedule in the resources now made available, if anything, is for the gNB (e.g. scheduler of the gNB) to make. For example, it may use all or some of the freed resources to send data to the same UE, to another UE, to a group of UEs (including the original UE or not), etc. or it may decide not to send any data in the resources.
If the UE does not transmit an ACK (positive feedback) in PUCCH#1 (e.g. transmits a NACK or does not transmit any acknowledgement feedback), the teachings provided above in respect of a NACK transmission can apply equally to this situation.

Accordingly, the UE may determine whether to send an acknowledgement feedback message in the uplink resources and alongside the radio conditions report (e.g. CSI or A-CSI) using one or more of the following techniques:
If the UE has been able to decode the downlink transmission before the uplink transmission, the UE transmits an ACK (positive feedback) in the uplink resources (e.g. PUCCH#1).
If the UE has not been able to decode the downlink transmission before the uplink transmission, the UE transmits a NACK (negative feedback) in the uplink resources (e.g. PUCCH#1).
If the UE has not been able to decode the downlink transmission before the uplink transmission, the UE does not transmit an acknowledgement feedback in the uplink resources (e.g. PUCCH#1).
If before the uplink transmission (1) the UE has not been able to decode the downlink transmission; (2) the UE has been able to decode the downlink transmission; or (3) regardless of whether the UE has been able to decode the downlink transmission or not, and if the UE has identified at least one further acknowledgment message to be transmitted in the PUCCH, the further acknowledgment message relating to another downlink transmission, the UE will multiplex the acknowledgement message for the downlink transmission and at least the further acknowledgement message in the uplink resources (e.g. PUCCH#1).

The UE can also provide a final HARQ-ACK in PUCCH#2. This may be done for example based on a set of one or more rules, such as one or more of:
A final acknowledgement feedback (e.g. HARQ-ACK) is always sent in PUCCH#2 regardless of whether the intermediate decoding attempt was successful and/or regardless of whether any feedback was sent in PUCCH#1;
   In the event that the intermediate decoding attempt was successful and that an ACK was sent, the terminal may send an ACK again without carrying out any further decoding attempt. For example, the UE may stop the decoding process for PDSCH#1 and simply repeat the ACK in PUCCH#2.
if the first HARQ-ACK in PUCCH#1 is a NACK (negative feedback), a final HARQ-ACK will be provided in PUCCH#2.
if no HARQ-ACK is sent in PUCCH#1, a final HARQ-ACK will be provided in PUCCH#2.
if no ACK (positive feedback) was sent in PUCCH#1, a final HARQ-ACK will be provided in PUCCH#2.

It should be appreciated that although this example shows a slot based PUCCH, this invention is applicable for sub-slot based PUCCH or any other arrangements. Likewise, as for the remainder of the present disclosure, teachings made with reference to HARQ-ACK, ACK, NACK, PUCCH and PDSCH apply equally to acknowledgement feedback, positive acknowledgement feedback, negative acknowledgement feedback, uplink resources or an uplink resource set, downlink resources or a downlink resource set or a downlink transmission, etc., respectively, and the examples herein are not limiting or prescriptive.

Thus from one perspective, the UE can be said to provide a Fast HARQ-ACK to the gNB which enables the gNB to optimize scheduling or otherwise optimise use of resources.

In the remainder of the present disclosure, the following terminology will be used in the interest of clarity the PUCCH that is scheduled for transmitting HARQ-ACK after all PDSCH repetitions will be referred to as the Original PUCCH (for example PUCCH#2 in FIG. 10)
the PUCCH that is scheduled for transmitting the A-CSI and Fast HARQ-ACK (if appropriate) will be referred to as Intermediate PUCCH or A-CSI PUCCH (for example PUCCH#1 in FIG. 10)

By combining (A-)CSI feedback with acknowledgement feedback, a fast acknowledgement scheme may be provided which can reduce latency in the system while having a limiting impact on the amount of resources to be used in accordance with the techniques discussed herein.

While it will usually be expected that the base station (or network equipment) will not normally modify the modulation and/or coding scheme for the remaining repetitions of the downlink transmission, this use case is conceivable and may be used in accordance with the techniques provided herein. For example, the terminal may be informed of a new MCS and/or of any resource scheduling changes (if appropriate) that may result from it and receive and decode the following repetitions on that basis. Accordingly, while it is expected that in most cases the adjustments to the transmissions of the repeated downlink transmissions will be in terms of power adjustments, the present disclosure is not limited to this example.

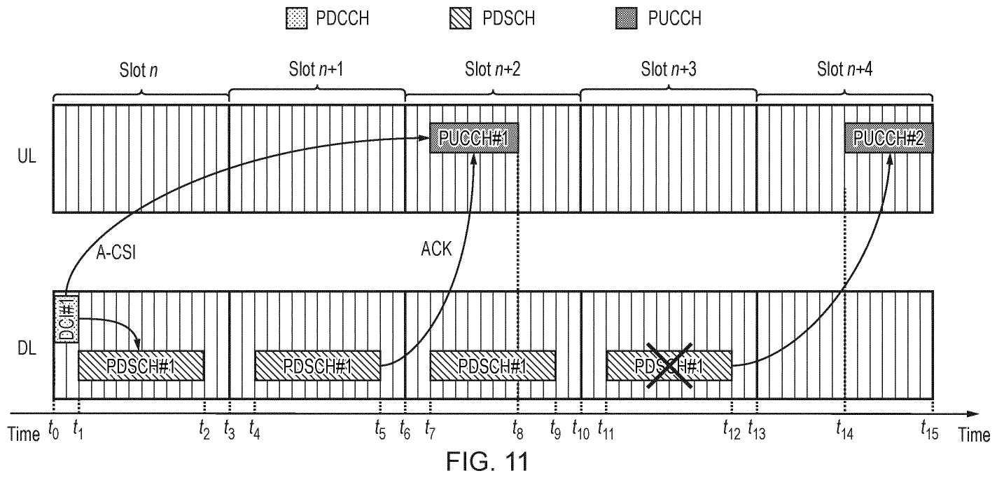

FIG. 11 illustrates an example use case based on the example FIG. 10, where repetitions are interrupted. In this example, and as an example implementation of a technique mentioned above, the said Fast HARQ-ACK is an ACK (positive acknowledgement), the UE may stop the decoding process and the gNB may terminate the transmissions of remaining PDSCH repetitions. Accordingly, the UE can save power by stopping the receiving, combining and decoding based on the remaining PDSCH repetitions, on the basis that it has already successfully received and decoded the PDSCH.

In the example of FIG. 11, the UE is able to successfully decode PDSCH#1 after two repetitions (in Slots n and n+1) and can send a positive feedback message as an ACK in PUCCH#1, alongside the requested A-CSI. The gNB receiving the ACK may then stop transmitting any further PDSCHs, as these will not be required and the UE has already been able to decode the PDSCH. In this example, the third repetition of PDSCH#1 in Slot n+2 would have already been sent before the gNB can update its scheduler based on the received acknowledgment message and/or CSI report, such that the fourth and last PDSCH#1 repetition in Slot n+3 would not be transmitted.

In some examples, the uplink resources may be used to transmit acknowledgement feedback only when the acknowledgement is positive. For example and looking at the example of FIG. 11, in a case where the UE is able to successfully decode the PDSCH after two repetitions, it may send an ACK in PUCCH#1 and in a case where the UE is not able to successfully decode the PDSCH before it can transmit any acknowledgement feedback on the PUCCH, it may only send the CSI report, without any (negative) acknowledgement feedback. Viewed differently, in some examples the UE only includes a HARQ-ACK feedback in the uplink transmission (e.g. PUCCH#1) if it has been able to successfully decode the PDSCH before the repetition ends (e.g. based on a partial number of repeated downlink transmissions) and/or before it can transmit using the uplink resources scheduled in the DL grant. Otherwise, the UE may only transmit the A-CSI in the uplink resources.

In this example, there is a reduction of the overhead in the PUCCH carrying the A-CSI. It will be appreciated that the HARQ-ACK feedback can consist of multiple bits. For example, in a case where the PDSCH is transmitted with multiple code-block groups and/or for multiple PDSCHs, the acknowledgement feedback may comprise multiple bits. Regarding multiple acknowledgements, it will be appreciated that as discussed above, in a case where the UE is also scheduled with at least a second PDSCH, PDSCH#2, the acknowledgement feedback for PDSCH#2 may be multiplexed with HARQ-ACK feedback for PDSCH#1 as discussed above, for example if they fall in the same PUCCH Multiplexing Window—or more generally if the terminal determines that the acknowledgement feedbacks will be multiplexed based on a feedback multiplexing scheme currently used by the terminal. In cases where acknowledgement feedbacks for one or more of the code block groups and/or PDSCHs are being transmitted, the UE may include HARQ-ACK feedback in the intermediate PUCCH, otherwise it may provide the (A-)CSI only (e.g. if the feedback for the intermediate PDSCH#1 decoding is negative).

It will appreciated that according to some techniques, the transmission of the radio conditions report (e.g. A-CSI) may implicitly communicate the acknowledgement feedback for the intermediate attempt at decoding the partial repeated transmissions. For example, the terminal and base station may be configured to communicate and understand the report communication according to a set of rules such as:
If a report (e.g. A-CSI) is transmitted in the uplink resources, this implicitly indicates a negative acknowledgement.
If a report (e.g. A-CSI) is not transmitted (e.g. using DTX), this implicitly indicates a positive acknowledgement.

Accordingly, the terminal may be able to communicate acknowledgement information in the uplink resources using a selection of a transmission of a report or a non-transmission of a requested report.

Likewise, the base station—or more generally infrastructure equipment—may be able to interpret the communication (including the lack of response to the report request or the report request being ignored) of the terminal as indicative of a positive or negative acknowledgement.

### Intermediate PUCCH or A-CSI PUCCH

In accordance with the techniques of the present invention, intermediate uplink resources (or resource set) which are scheduled for transmitting a requested radio report may be used to transmit a notification of acknowledgment information (implicitly or explicitly). The following provide examples of resources for an intermediate or A-CSI PUCCH.

In an example, the resources for the A-CSI PUCCH are at least partially configured via RRC signalling. For example, the A-CSI PUCCH resource set can be configured such that it is available after N slots from the slot of the first PDSCH repetition (where N=1 points to the slot of the first repetition) or after the m^{th} repetition. This can for example be X symbols and/or Y slots (e.g. Y=1) after the end of the m^{th} PDSCH repetition. Accordingly, parameters m and/or N can be configured via RRC and the terminal and base station can both determine that the uplink resource set can be found in a location (e.g. a partially or fully predetermined and/or configured location) at the N^{th} slot or after the m^{th} repeated downlink transmission. In this case, N refers to the number of slots but it will appreciated that the same considerations apply to sub-slots and other time units. How to identify the resource or resource set in a slot or other time unit is discussed further below (and may in some case rely on a PRI parameter or equivalent).

In some examples, the value(s) for m and/or N can be set as an absolute value or as a relative value, e.g. half of the number of repetitions or slots for the entire repetition sequence, respectively. An example of the use of a relative value may be that, if four PDSCH repetitions are configured with one in each slot, then m and/or N may be set to two, i.e. half of the number of repetitions or slots, respectively. By setting the value m and/or N to be before the end of the repetition sequence, and in some case before the penultimate repetition at the latest, and by locating the intermediate uplink resource before these points, the remaining downlink transmissions can benefit from the Fast HARQ-ACK and A-CSI notification mechanism in place.

In a further example, there may be a predetermined configuration for identifying the resource scheduled for the intermediate report transmission. For example, this may rely at least partially on using a standardised, pre-agreed or otherwise configured time period after the DL Grant, after the first PDSCH repetition or slot, or after an m^{th} or N^{th} PDSCH repetition or slot (respectively). Accordingly, in some cases, the resource for A-CSI PUCCH is fixed in the specifications. The identification of the UL resource may also involve at least the use of more dynamic configuration methods.

Dynamic Indicator

In some examples, the availability of the resource set for the A-CSI PUCCH can at least partially be dynamically indicated in the DL Grant.

For example, such a dynamic indicator for identifying the A-CSI PUCCH resource set may be one or more DCI fields in the DL Grant (e.g. existing and/or newly introduced fields). It will be appreciated that the reference to a DCI (or other) “field” can be seen as a reference to a parameter or configuration element. Such fields can for example include one or more of the following:
The existing DCI field containing the K₁ value, which can be re-used to identify a slot after slot N for the associated intermediate PUCCH. The K₁ value for the Intermediate PUCCH (in the interest of clarity, the K₁ value for the intermediate PUCCH will be referred to as K_{1′}) can be identical to the Ki configured for the Original PUCCH in accordance with the discussions above(but they may have different reference points, e.g. K₁ can refer to the last PDSCH repetition whereas K_{1′} can refer to the 1^{st}—or another reference—PDSCH repetition).
A new DCI field to indicate a K_{1′} value for intermediate PUCCH configuration or identification.
A new PUCCH resource indicator (PRI) field to indicate the PUCCH Resource for intermediate PUCCH configuration or identification.
A joint K_{1′} and PRI field to indicate K_{1′} and PUCCH Resources for intermediate PUCCH configuration

In a case where a parameter K_{1′} is used, it may be used in a manner similar to parameter K₁ discussed above, namely to identify a slot which is K₁ slot(s) after a reference slot. There may be different ways to identify a reference slot. For example, if the reference slot (e.g. slot N) is defined as half of the total number of slots for the PDSCH repetition sequence (e.g. Nₜₒₜₐₗ) then the PUCCH may then be found in slot Nₜₒₜₐₗ/2+K_{1′}, with reference to the 1^{st} PDSCH repetition. In another example, the reference slot may be identified based on a number of repetitions. If for example the reference number of repetitions m is half of the total number of repetitions M, then the PUCCH may then be found Ki' slot(s) after the slot where the m^{th} repetition can be found with m=M/2. While slots have been used as reference time units, as with any other parts of this description, other time units such as sub-slots or otherwise, may be used. In cases where a downlink transmission repetition spans across more than one time unit, the reference one may be pre-agreed, for example as the last time unit where the repetition can be found. It will also be appreciated that in cases where a calculation involves dividing a number (e.g. of repetitions or slots) by a number other than a divisor of that number, the outcome may be rounded as appropriate, e.g. rounded up, rounded down, etc.

In some instances, the dynamic indicator for identifying the intermediate PUCCH resource or resource set may use the “PDSCH-to-HARQ_feedback timing indicator” DCI field in the DL Grant. The “PDSCH-to-HARQ_feedback timing indicator” is conventionally used to indicate an index to a lookup table for the K₁ value for the Original PUCCH. In this example, a K₁ value or configuration may be associated with each K₁ value. From one perspective this can be seen as a lookup table containing a column for K₁ (similarly to what is being used in current systems) as well as an additional column for providing another K₁ value for the A-CSI PUCCH (i.e. K_{1′} with the terminology used herein).

An example of such a lookup table is shown in Table 1 below, illustrating a look up table for a 2 bit “PDSCH-to-HARQ_feedback timing indicator”. In this example, an additional column is included for the A-CSI PUCCH K_{1′} values in conjunction with the existing Original PUCCH K₁ values. Accordingly, for each index indicated by the “PDSCH-to-HARQ_feedback timing indicator” field, the UE gets two K 1 values, one for the Original PUCCH (K₁) and another for the A-CSI PUCCH (K_{1′}). The provided configurations associated with the Index values may in some cases be used to indicate that “No A-CSI PUCCH” is required as illustrated in Table 1 below (although in other cases each index may be associated with a corresponding K_{1′} value).

TABLE 1

| | K₁ | K₁′ |
|---|---|---|
| Index | (Original PUCCH) | (A-CSI PUCCH) |
| 00 | 2 | 1 |
| 01 | 3 | 2 |
| 10 | 5 | 1 |
| 11 | 10 | No A-CSI PUCCH |

As will be appreciated, the value K_{1′} (like K₁) is a relative value such that, if used, it may be associated with a reference point. For example, a suitable reference point for K_{1′} may be determined based on one or more rules or configurations such as:
K_{1′} is relative to the end of the PDCCH carrying the DL Grant
K_{1′} may be configured to be after the first repetition of the PDSCH or after the second repetition of the PDSCH
K_{1′} is relative to the end of the m^{th} PDSCH repetition, where the value for m can be configured via RRC signalling and/or configured based on predetermined values (e.g. standardised values), e.g. m=1 (the end of 1st PDSCH repetition). It will be appreciated that in some cases, parameter m may correspond or be identical to parameter N discussed above, for example where one repetition is transmitted per slot.
K_{1′} and K₁ can use different units: for example K_{1′} may be defined in units of sub-slots of a first length (e.g. 2 symbols) whilst Ki for the Original PUCCH uses units of slot or sub-slot of a different length (e.g. 7 symbols). While it is expected that in many cases the units for K_{1′} will correspond to a short time period relative to the units for K₁, this may not always be the case.

In another example, a dynamic indicator for the A-CSI/Intermediate PUCCH resource set may be the “PUCCH Resource Indicator” (PRI) field in the DL Grant. In current systems, the PRI is a 3 bit indicator that points to an index in a PUCCH Resource lookup table. In this example, the A-CSI PUCCH resource set can be configured as being the same as the one used for the Original PUCCH (albeit in a different slot/sub-slot compared to the Original PUCCH). Presented differently, the base station and terminal may use a parameter which configures, in a time unit (e.g. slot, sub-slot or otherwise), which resources will be used. Accordingly, once the base station and terminal can each determine in which time unit the Intermediate and Original PUCCHs will be transmitted, a single indicator can be used to identify the two PUCCHs individually and separately. The PRI (or equivalent indicator) can thus be used to indicate the frequency resource, duration and starting symbol relative to the indicated slot boundary for the PUCCH.

In yet another example, a dynamic indicator for A-CSI/Intermediate PUCCH resource set may be the “PUCCH Resource Indicator” (PRI) field in the DL Grant where the same PRI parameter may point to different resources for the Original and Intermediate PUCCH. For example, this can be seen as associating with each PRI value a PUCCH Resource lookup table containing a set of configurations for the Original PUCCH (e.g. similarly to what is currently used to identify resources for a PUCCH using the PRI) as well as an additional set of configurations provided for the indicating or identifying the PUCCH resources for the A-CSI/Intermediate PUCCH.

In a variant of this example, the PRI parameter may be associated with different configurations or values for the A-CSI/Intermediate PUCCH depending on whether the Intermediate PUCCH is to be used for notifying a positive or negative acknowledgement for an intermediate decoding attempt. In such an example, based on the PRI and the HACK-ACK status, the UE may choose the appropriate PUCCH resource to transmit one or both of the A-CSI and HARQ-ACK feedback. As discussed above, HARQ-ACK feedback may in some cases only be included if positive (ACK) feedback is to be signalled or notified and/or the A-CSI report may only be transmitted if negative (NACK) feedback is to be signalled or notified. It will be appreciated that the amount of physical resources used to transmit the intermediate PUCCH may in some cases be different, depending on how the terminal is configured to send acknowledgement feedback and CSI reports. For example, in some cases more PUCCH resources may be used for transmission of a PUCCH associated with positive HARQ-ACK feedback containing an ACK (e.g. in a case where a positive ACK is signalled explicitly and negative ACKs are not sent, while A-CSI reports are always sent).

In some cases, a dynamic indicator for the A-CSI/Intermediate PUCCH resource may be the “Time domain resource assignment” (TDRA) field in the DL Grant. The TDRA field indicates the time resource for the PDSCH and includes a starting slot offset K₀ from the DL Grant (for the first slot in which the PDSCH will be transmitted), the symbol offset S from the start of the slot indicated by K₀ i and the duration L of the PDSCH. More details may be found about the TDRA parameter in patent reference [7], the content of which is hereby incorporated by reference in its entirety.

In this example, the TDRA values may be associated with additional information for identifying the resources for the A-CSI PUCCH, such as the PUCCH Resource in time (e.g. K_{1′} value as discussed above) and/or frequency resources (e.g. as discussed in respect of the PRI above). From one perspective, the TDRA configuration may be viewed as a mapping table wherein the mapping table may be used to map a time and/or frequency configuration used to identify the resources for carrying the intermediate PUCCH.

An example of a 2 bit TDRA indicator is shown in Table 2 below, which in this case includes both the K_{1′} and PRI value or configuration mappings. In this example, the last entry (index=11) does not contain any A-CSI PUCCH resource which indicates that an A-CSI is not triggered. The third entry (index=10) indicates that the PRI for A-CSI PUCCH follows the same PRI as that used for the Original PUCCH. Accordingly, the PRI may be configured by reference to one or more corresponding parameter(s) for the Original PUCCH.

TABLE 2

| TDRA Index | K₀ | S | L | K₁′ (A-CSI PUCCH) | PRI |
|---|---|---|---|---|---|
| 00 | 2 | 3 | 8 | 1 | 2 |
| 01 | 1 | 0 | 10 | 2 | 1 |
| 10 | 0 | 3 | 11 | 1 | Original |
| 11 | 2 | 5 | 7 | No A-CSI | N/A |

As will be appreciated, the different example techniques above may be used independently or combined (e.g. partially or fully) as appropriate, so long as the combination is conceivable. An example of combined embodiment is to use mapping for the “PDSCH-to-HARQ_feedback timing indicator” (e.g. as illustrated in Table 1) for determining one or more time parameters with the “PUCCH Resource Indicator” PRI techniques discussed above for determining one or more frequency parameters. As mentioned above in respect of table 2, the TDRA (or a similar time configuration scheme) may be used where the mapping can provide in some cases one or more configuration values and in other cases references to other configuration determination schemes or parameters (e.g. the Original PRI for TDRA index 10 above). In another illustrative example, the techniques discussed for the “PDSCH-to-HARQ_feedback timing indicator” (or other timing indicator for determining resources) may be used to configure one or more timing parameters for the Intermediate PUCCH (e.g. K_{1′}) and may also be used in combination with another indicator, e.g. an indicator provided in the PRI or equivalent for determining at least the frequency resources.

A-CSI Trigger Indicator

In many cases in accordance with the present techniques, the resource or resource set for an A-CSI PUCCH will only be scheduled if the DL Grant triggers or requests an A-CSI. In such cases, the UE would only transmit acknowledgement feedback in the Original PUCCH (or in any otherwise scheduled resources for acknowledgement feedback). From one perspective, the teachings discussed herein provide techniques for a terminal to use uplink resources already scheduled for transmitting a report, wherein the resources are used for providing a notification of at least one positive or negative acknowledgement feedback.

In some cases, the existing “CSI request” field in the UL Grant can be introduced for use in the DL Grant or a new DCI field can be introduced for the DL Grant which can be used to trigger or request an A-CSI. Accordingly, if the DL Grant does not trigger or request an A-CSI, the UE would ignore the K_{1′} values for A-CSI PUCCH in Table 1 or any other configuration for the A-CSI PUCCH and the UE would not transmit any A-CSI PUCCH during the repetitions (e.g. after a N^{th} PDSCH repetition, which may be configured by RRC signalling).

### Original PUCCH

While the discussion above focusses mostly on the configuration and use of the Intermediate or A-CSI PUCCH, different approaches may be used for the Original PUCCH, depending on the repeated downlink transmission (PDSCH#1) and/or on other transmissions which may affect transmissions.

In an embodiment, if the positive feedback is notified (implicitly or explicitly) using the A-CSI PUCCH, HARQ-ACK feedback for the downlink transmission (e.g. PDSCH#1) may be not transmitted in the Original PUCCH as the base station has already been notified that the terminal has been able to successfully decode the downlink transmission.

In some implementations, whether to transmit in the Original PUCCH or not may depend on other transmissions. If the Original PUCCH does not contain multiplexed HARQ-ACK from any other PDSCHs or UCI, then the Original PUCCH may not be transmitted at all. Said differently, the terminal may not transmit any signals in the Original PUCCH's resources (e.g. DTX). If other acknowledgement feedback may be multiplexed or may use or share the Original PUCCH resources, then different techniques may be used.

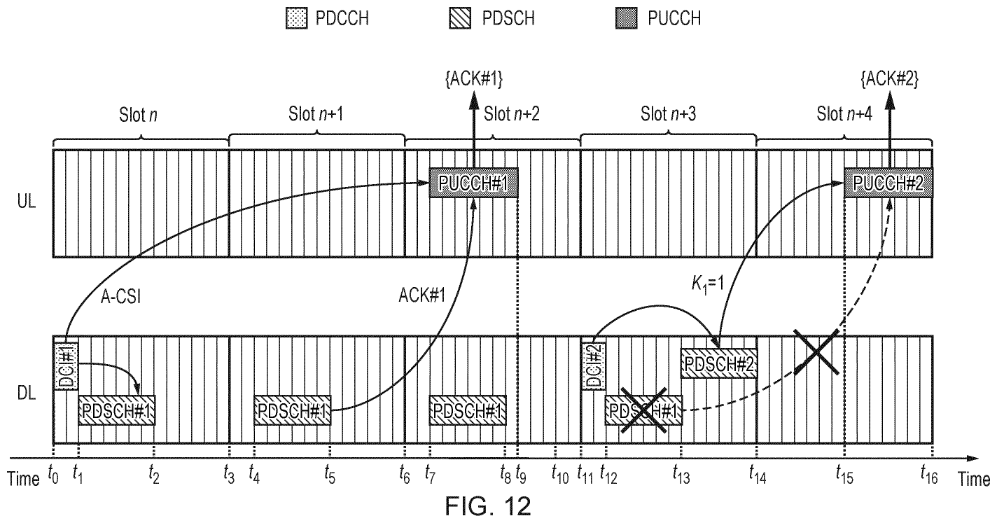

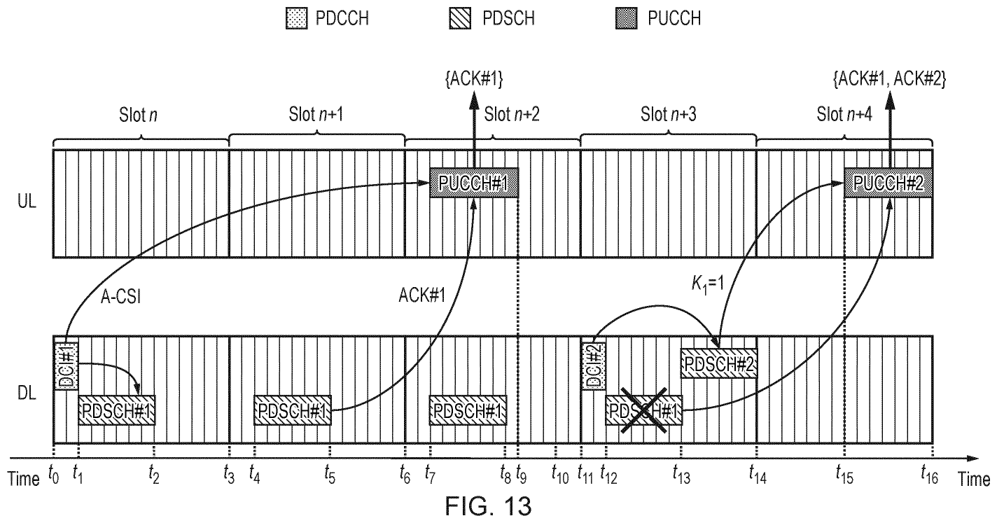

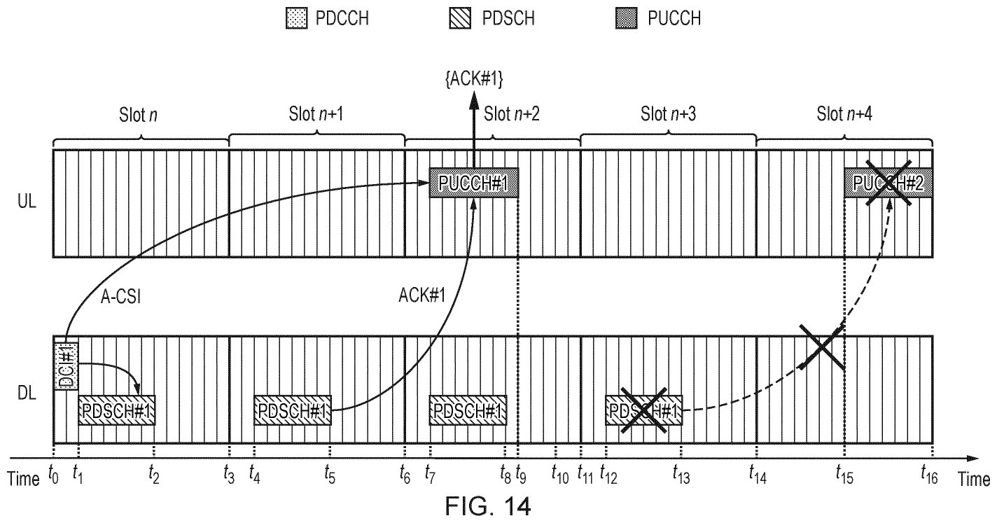

Accordingly, the decision on whether to use the original PUCCH to transmit acknowledgement feedback for the downlink transmission (e.g. PDSCH#1) may be based on one or more of the considerations discussed below:
In some cases, if the Fast HARQ-ACK (intermediate acknowledgement) indicates an ACK (positive feedback) in the A-CSI PUCCH, then the UE does not transmit the ACK again in the Original PUCCH, regardless of whether the Original PUCCH will also be used to transmit other UCI (e.g. SR) or HARQ-ACK for other PDSCHs. FIG. 12 illustrates an example of notifications of acknowledgement feedback using intermediate and original uplink resources. As shown in FIG. 12, DCI#1 schedules PDSCH#1 with four repetitions and also triggers an A-CSI report with an associated A-CSI PUCCH resource set (PUCCH#1) while the Original PUCCH resource set (PUCCH#2) is provided for conventional acknowledgement of the entire repetition sequence.
In this example, the UE successfully decodes PDSCH#1 after two repetitions and notifies the gNB with a positive acknowledgement feedback (ACK) on PUCCH#1. The gNB may for example decide to terminate PDSCH#1 repetitions early (as illustrated in FIG. 12). At time t₁₁, DCI#2 schedules PDSCH#2 for the same UE, where its HARQ-ACK (acknowledgement feedback) is expected to be carried in PUCCH#2 as well. Although PUCCH#2 was initially scheduled to multiplex HARQ-ACK for PDSCH#1 and PDSCH#2, since an ACK (positive feedback) has already been sent for PDSCH#1 in the PUCCH#1, the acknowledgement feedback for PDSCH#2 (e.g. ACK or NACK) for PDSCH#2 is sent in PUCCH#2 and is not multiplexed with the positive feedback for PDSCH#1 (labelled as ACK#1).
In some cases, if the Fast HARQ-ACK (intermediate acknowledgement) indicates an ACK (positive feedback) in the A-CSI PUCCH, then the UE can transmit the ACK again in the Original PUCCH if the Original PUCCH also multiplexes other UCI (e.g. SR) or HARQ-ACK for other PDSCHs. FIG. 13 illustrates another example of notifications of acknowledgement feedback using intermediate and original uplink resources, in accordance with example implementation. The situation is similar to that discussed above in respect of FIG. 12. However, here ACK#1 is multiplexed into PUCCH#2 since PUCCH#2 carries UCI for PDSCH#2. Since PUCCH#2 will be transmitted at least for transmitting ACK#2, the overhead saving when not sending ACK#1 is relatively limited such that ACK#1 is transmitted again with a limited impact on the overall performance.
The terminal may be confirmed not to transmit the ACK in the Original PUCCH if the Original PUCCH contains only feedback information for that PDSCH (e.g. PDSCH#1). For example, FIG. 14 illustrates a further example of notifications of acknowledgement feedback using intermediate and original uplink resources. In this case, where the situation is similar to that of FIGS. 12 and 13 but where there is no other acknowledgement feedback, UCI or other uplink data to multiplex in the Original uplink resource set. In this case, the terminal can dispense from the sending the acknowledgement feedback in the resources originally allocated for this transmission (Original PUCCH).

As will be appreciated, the decision on whether to use the Original PUCCH to send acknowledgement feedback for the repeated downlink transmission may also depend on the type of intermediate feedback previously notified or transmitted. For example, if the intermediate feedback was negative (e.g. if there was no positive intermediate feedback for the transmission prior to the Original uplink resource set), the terminal may use the Original resource to transmit feedback based on a decoding attempt using all repetitions of the transmission. This recognises that although the UE may sometimes not be able to decode the PDSCH successfully with partial repetitions, it may be able to decode the PDSCH successfully once all repetitions have been received and used for the decoding—such that the UE may still wish to indicate an ACK in the Original PUCCH.

### EXAMPLE METHODS

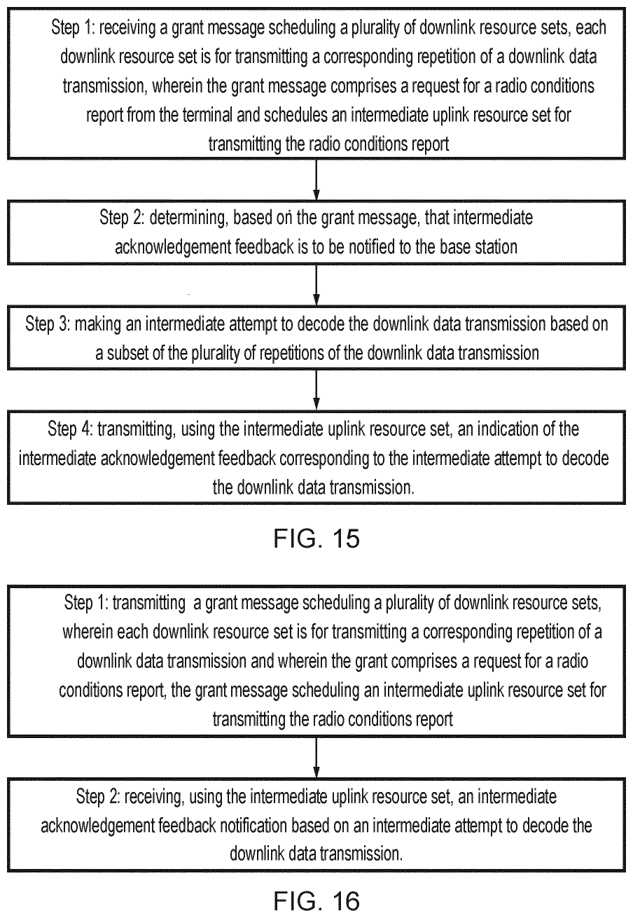

FIGS. 15 and 16 illustrate example methods in accordance with the present disclosure where the method of FIG. 15 may for example be implemented by a terminal and where the method of FIG. 16 may for example be implemented by an infrastructure equipment, such as a base station, gNB, relay node, etc. as appropriate.

Considering FIG. 15 first, at step 1 a grant message is received which schedules a plurality of downlink resource sets, each downlink resource set being for transmitting a corresponding repetition of a downlink data transmission. The grant message also comprises a request for a radio conditions report (e.g. CSI or A-CSI) from the terminal and schedules an intermediate uplink resource set for the terminal to transmit the radio conditions report on the uplink. The grant message may for example be a downlink grant.

At step 2, it may then be determined, based on the grant message, that intermediate acknowledgement feedback is to be notified to the base station. This may for example be based on the presence of the request in the grant: the terminal may treat this as an indication that it is an opportunity to transmit a Fast HARQ-ACK or Intermediate Feedback notification.

At step 3, an intermediate attempt is made to decode the downlink data transmission based on a subset of the plurality of repetitions of the downlink data transmission.

At step 4, the intermediate uplink resource set is used to transmit an indication of whether the intermediate attempt to decode the downlink data transmission was successful or not by transmitting an indication of the corresponding intermediate acknowledgement feedback. In view of the discussion above, this notification or indication may sometimes be explicit (e.g. positive or negative) and may sometimes be implicit (e.g. based on the presence or absence of a report in the intermediate uplink resource set).

Looking at FIG. 16, at step 1 a grant message is transmitted which schedules a plurality of downlink resource sets, each downlink resource set being for transmitting a corresponding repetition of a downlink data transmission. The grant also comprises a request for a radio conditions report and schedules an intermediate uplink resource set for transmitting the radio conditions report.

At step 2: an intermediate acknowledgement feedback notification is received, using the intermediate uplink resource set, wherein the notification is based on an intermediate attempt to decode the downlink data transmission based on a subset of the plurality of repetitions of the downlink data transmission. As mentioned above, the notification or indication may be implicit or explicit.

Further considerations

It will be appreciated that while the examples above refer repeatedly to A-CSI, the teachings and techniques discussed herein are not limited to A-CSI but are relevant to any CSI or equivalent mechanism for obtaining an on-request radio conditions report or measurement. In current systems, this will likely be using a mechanism like A-CSI but the disclosure is not limited to this implementation. The teachings are also applicable to the case where a downlink grant triggers the UE to transmit sounding reference signals (SRS) upon which a base station can perform measurements of the uplink channel, where the UE can transmit intermediate feedback information in conjunction with the SRS.

While the present disclosure has been provided with a single intermediate PUCCH transmitted between the start and the end of the repetition sequence, it will be appreciated that in other cases two or more

Intermediate PUCCH may be scheduled for a requested radio conditions report and may be used to notify the network or base station of an intermediate acknowledgement feedback for an intermediate decoding attempt. In such cases, a plurality of Intermediate PUCCH may be used to signal A-CSI and/or Fast HARQ-ACK at different points during the PDSCH repetition process. This can for example be beneficial for longer PDSCH repetitions.

It should also be noted that in such a case, different techniques may be used for different ones of the multiple intermediate PUCCH, although it is expected that using the same schemes and techniques would help simplify the implementation of the base station and terminal.

The term resource set, resources or resource can refer to any suitable set of time and frequency resources to be used to transmit signals on the wireless interface. This may be measured in some cases based on a unit of resource block, sub-slot, slot, frame or any other resource (time and/or frequency) unit deemed appropriate.

Additionally, the method steps discussed herein may be carried out in any suitable order. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example, transmitting a message may involve using several resource elements in an LTE or NR environment such that several signals at a lower layer correspond to a single message at a higher layer. Also, transmissions from one node to another may relate to the transmission of any one or more of user data, system information, control signalling and any other type of information to be transmitted. It will also be appreciated that some information may be notified or indicated implicitly rather than through the use of an explicit indicator.

Also, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system as well as for the corresponding computer program. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a mobile node or network node may be configured accordingly if appropriate, so long as it is technically feasible and not explicitly excluded.

Whenever the expressions “greater than” or “smaller than” or equivalent are used herein, it is intended that they disclose both alternatives “and equal to” and “and not equal to” unless one alternative is expressly excluded.

It will be appreciated that while the present disclosure has in some respects focused on implementations in a 5G or NR network as such a network is expected to provide the primary use case at present, the same teachings and principles can also be applied to other wireless telecommunications systems. Thus, even though the terminology used herein is generally the same or similar to that of the 5G (or LTE) standards, the teachings are not limited to the present versions of 5G (or LTE) and could apply equally to any appropriate arrangement not based on 5G/LTE, for example any arrangement possibly compliant with any future version of an LTE, 5G or other standards—defined by the 3GPP standardisation groups or by other groups. Accordingly, the teaching provided herein using 3GPP, LTE and/or 5G/NR terminology can be equally applied to other systems with reference to the corresponding functions. For example, references to HARQ-ACK or DCI can be more generally understood as references to acknowledgements (positive or negative) or control information relating to the downlink.

It will be appreciated that the principles described herein are applicable not only to certain types of communications device, but can be applied more generally in respect of any types of communications device. For example, while the techniques are expected to be particularly useful for systems using NR-U communications, the skilled person will appreciate that they can also be applied more generally, for example in respect of any type of communications device operating with a wireless link to the communication network, or for peer-to-peer transmissions (either transmissions ending at another node of the radio access network, e.g. a communication device or any other type of node in the network, or transmissions to or from the main or core network and going through a mesh network in the radio access network).

It is noteworthy that where a “predetermined” element is mentioned, it will be appreciated that this can include for example a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product, comprising for example computer-readable instructions stored on a computer readable medium which can be executed by a computer, for carrying out a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely examples of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered clauses:

Clause 1. A method for communicating in a mobile communications network, the network comprising a network equipment configured to provide a wireless interface to communicate with at least a terminal, the method comprising:
receiving, at the terminal, a grant message scheduling a plurality of downlink resource sets, wherein each of the plurality of downlink resource sets is for transmitting a corresponding one of a plurality of repetitions of a downlink data transmission,
wherein the grant message further comprises a request for a radio conditions report from the terminal and schedules an intermediate uplink resource set for transmitting the radio conditions report; determining, based on the grant message, that intermediate acknowledgement feedback is to be notified to the base station;
making an intermediate attempt to decode the downlink data transmission based on a subset of the plurality of repetitions of the downlink data transmission; and transmitting, using the intermediate uplink resource set, an indication of the intermediate acknowledgement feedback corresponding to the intermediate attempt to decode the downlink data transmission.

Clause 2. The method of Clause 1 wherein the method further comprises, if the intermediate attempt is successful, transmitting an indication of a positive intermediate acknowledgement feedback message and stopping further attempts to decode the downlink data transmission.

Clause 3. The method of Clause 1 or 2 wherein the method further comprises, if the intermediate attempt is successful, transmitting no further acknowledgement feedback messages for the downlink data transmission.

Clause 4. The method of any preceding Clause wherein transmitting further comprises transmitting a radio conditions report in response to the request.

Clause 5. The method of any preceding Clause wherein if the intermediate attempt is successful, not transmitting in the intermediate uplink resource set thereby providing a notification of a successful intermediate attempt;
if the intermediate attempt is unsuccessful, transmitting the radio conditions report in the intermediate uplink resource set, thereby providing a notification of a successful intermediate attempt.

Clause 6. The method of any preceding Clause wherein the grant message schedules a second uplink resource set for transmitting a final acknowledgement feedback message for the downlink data transmission using the plurality of repetitions and wherein the method further comprises transmitting, using the second uplink resource set, the final acknowledgement feedback message for the downlink data transmission.

Clause 7. The method of Clause 6, wherein if the intermediate attempt is successful: if it is determined that the second uplink resource set is also for transmitting another acknowledgement feedback message, wherein the other acknowledgement feedback message is for another downlink data transmission, transmitting the final acknowledgement feedback message and the other acknowledgement feedback message, using the second uplink resource set;
if it is determined that the second uplink resource set is not to be used for transmitting another acknowledgement feedback message, not transmitting the final acknowledgement feedback message in the second uplink resource set.

Clause 8. The method of any preceding Clause further comprising:
if the intermediate attempt is successful, transmitting, an intermediate acknowledgement feedback message in the intermediate uplink resource set;
if the intermediate attempt is unsuccessful, transmitting, the radio conditions report in the intermediate uplink resource set without an explicit intermediate acknowledgement feedback message for the unsuccessful intermediate attempt.

Clause 9. The method of any preceding Clause wherein determining, based on the grant message, that intermediate acknowledgement feedback is to be notified to the base station comprises:
identifying whether the grant message comprises a request for a radio conditions report;
if the grant message comprises a request for a radio conditions report, determining that intermediate acknowledgement feedback is to be notified to the base station using the intermediate uplink resource set;

Clause 10. The method of Clause 9 wherein determining, based on the grant message, that intermediate acknowledgement feedback is to be notified to the base station further comprises if the grant message does not comprise a request for a radio conditions report, determining that no intermediate acknowledgement feedback is to be notified using the intermediate uplink resource set.

11. The method of any preceding Clause wherein the intermediate uplink resource set is before the end of the plurality of the downlink resource sets.

Clause 12. The method of any preceding Clause , wherein the grant message comprises location information for identifying the location of the uplink resource set, the location information comprising one or more of:
a number K1′ of time units after a reference time unit, wherein the uplink resource set is provided in the K1′^{th} time unit after the reference time unit;
a number m of repetitions wherein the m th repetition of the downlink data transmission identifies a reference time unit for identifying the location of the uplink resource set;
a number N of time units, wherein the N th time unit is identified as a reference time unit for identifying the location of the uplink resource set;
a Physical Resource Indicator “PRI” indicating one or more of: a frequency resource, a duration and a starting symbol for identifying the location of the uplink resource set; and
a Time Domain Resource Indicator comprising one or both of: an uplink resource set start time, an uplink resource set start time as a symbol offset from a start time of a time unit, a duration of the uplink resource set and a duration of the uplink resource as a number of symbol from an uplink resource set start time.

Clause 13. A method for communicating in a mobile communications network, the network comprising a network equipment configured to provide a wireless interface to communicate with at least a terminal, the method comprising:
transmitting, at the network equipment, a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and
receiving, using the intermediate uplink resource set, an intermediate acknowledgement feedback notification based on an intermediate attempt to decode the downlink data transmission based on a subset of the plurality of repetitions of the downlink data transmission.

Clause 14. The method of Clause 13, further comprising: if the intermediate acknowledgement feedback message indicates a successful intermediate attempt, stopping the transmission of the plurality of repetitions of the downlink data transmission.

Clause 15. The method of Clause 13 or 14, further comprising: if the intermediate acknowledgement feedback message indicates an unsuccessful intermediate attempt, continuing the transmission of the plurality of repetitions of the downlink data transmission.

Clause 16. The method of any one of Clauses 13 to 15, further comprising receiving, using the intermediate uplink resource set a radio conditions report in response to the request.

Clause 17. A terminal for use in a mobile communications network, the network comprising a network equipment configured to provide a wireless interface to communicate with at least the terminal, the terminal being configured to:
receive a grant message scheduling a plurality of downlink resource sets, wherein each of the plurality of downlink resource sets is for transmitting a corresponding one of a plurality of repetitions of a downlink data transmission,
wherein the grant message further comprises a request for a radio conditions report from the terminal and schedules an intermediate uplink resource set for transmitting the radio conditions report;
determine, based on the grant message, that intermediate acknowledgement feedback is to be notified to the base station;
make an intermediate attempt to decode the downlink data transmission based on a subset of the plurality of repetitions of the downlink data transmission; and
transmit, using the intermediate uplink resource set, an indication of the intermediate acknowledgement feedback corresponding to the intermediate attempt to decode the downlink data transmission.

Clause 18. The terminal of Clause 17, further configured to implement the method of any one of Clauses 1 to 12.

Clause 19. A network equipment for use in a mobile communications network, the network equipment being configured to provide a wireless interface to communicate with at least a terminal of the mobile communications network, the network equipment being further configured to:
transmit a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and
receive, using the intermediate uplink resource set, an intermediate acknowledgement feedback notification based on an intermediate attempt to decode the downlink data transmission based on a subset of the plurality of repetitions of the downlink data transmission.

Clause 20. The network equipment of Clause 19 further configured to implement the method of any one of Clauses 13 to 16.

21. A system comprising a terminal according to Clause 17 or 18 and a network equipment according to Clause 19 or 20.

22. Circuitry for a terminal in a mobile communications network, wherein the circuitry comprises a controller element and a transceiver element configured to operate together to connect to the mobile telecommunication network via a wireless interface provided by network equipment of the network, wherein the controller element and the transceiver element are further configured to operate together to
receive a grant message scheduling a plurality of downlink resource sets, wherein each of the plurality of downlink resource sets is for transmitting a corresponding one of a plurality of repetitions of a downlink data transmission,
wherein the grant message further comprises a request for a radio conditions report from the terminal and schedules an intermediate uplink resource set for transmitting the radio conditions report; determine, based on the grant message, that intermediate acknowledgement feedback is to be notified to the base station;
make an intermediate attempt to decode the downlink data transmission based on a subset of the plurality of repetitions of the downlink data transmission; and
   transmit, using the intermediate uplink resource set, an indication of the intermediate acknowledgement feedback corresponding to the intermediate attempt to decode the downlink data transmission.

23. Circuitry for a terminal in a mobile communications network, wherein the circuitry comprises a controller element and a transceiver element configured to operate together to connect to the mobile telecommunication network via a wireless interface provided by network equipment of the network, wherein the controller element and the transceiver element are further configured to operate together to implement the method of any one of Clauses 1 to 12.

24. Circuitry for network equipment in a mobile communications network, wherein the circuitry comprises a controller element and a transceiver element configured to operate together to provide a wireless interface to communicate with at least a terminal of the mobile communications network, wherein the controller element and the transceiver element are further configured to operate together to:
transmit a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and
receive, using the intermediate uplink resource set, an intermediate acknowledgement feedback notification based on an intermediate attempt to decode the downlink data transmission based on a subset of the plurality of repetitions of the downlink data transmission.

Clause 25. Circuitry for network equipment in a mobile communications network, wherein the circuitry comprises a controller element and a transceiver element configured to operate together to provide a wireless interface to communicate with at least a terminal of the mobile communications network, wherein the controller element and the transceiver element are further configured to operate together to implement the method of any one of Clauses 13 to 16.

Clause 26. A computer program product comprising instructions which, when the program is executed by a computer, cause the computer to carry out the method of any one of Clauses 1 to 12 and 13 to 16.

### ACRONYMS

A-CSI Aperiodic Channel State Information
AMC Adaptive Modulation and Coding
CSI Channel State Information
CSI-RS Channel State Information Reference Signals
DCI Downlink Control Information
DG-PDSCH Dynamic Grant PDSCH
DL Downlink
DTX Discontinuous Transmission
PDSCH Physical Downlink Channel
NR New Radio
PDCCH Physical Downlink Control Channel
PDSCH Physical Downlink Shared Channel
PRI PUCCH Resource Indicator
PUCCH Physical Uplink Control Channel
PUSCH Physical Uplink Shared Channel
RRC Radio Resource Control
SR Scheduling Request
TB Transport Block
UCI Uplink Control Information
UL Uplink

### REFERENCES

[1] 3GPP document RP-160671, “New SID Proposal: Study on New Radio Access Technology,” NTT DOCOMO, RAN#71, Gothenburg, Sweden, 7 to 10 Mar. 2016

[2] 3GPP document RP-172834, “Work Item on New Radio (NR) Access Technology,” NTT DOCOMO, RAN#78, Lisbon, Portugal, 18 to 21 Dec. 2017

[3] 3GPP document RP-182089, “New SID on Physical Layer Enhancements for NR Ultra-Reliable and Low Latency Communication (URLLC),” Huawei, HiSilicon, Nokia, Nokia Shanghai Bell, RAN#81, Gold Coast, Australia, 10 to 13 Sep. 2018

[4] 3GPP document RP-190654, “New WID: Physical layer enhancements for NR ultra-reliable and low latency communication (URLLC),” Huawei, HiSilicon, RAN#83, Shenzhen, China, 18 to 21 Mar. 2019

[5] 3GPP document TR38.913, “Study on Scenarios and Requirements for Next Generation Access Technologies (Release 14)”, v14.3.0

[6] 3GPP document RP-190726, “Physical layer enhancements for NR ultra-reliable and low latency communication (URLLC),” Huawei, HiSilicon, RAN#83

[7] 3GPP document RP-193233, “Enhanced Industrial Internet of Things (loT) and URLLC support,” Nokia, Nokia Shanghai Bell, RAN#86

[8] 3GPP document RP-191575, “NR-based Access to Unlicensed Spectrum,” Qualcomm, RAN#84

[9] Holma H. and Toskala A, “LTE for UMTS OFDMA and SC-FDMA based radio access”, John Wiley and Sons, 2009

[10] 3GPP document RP-201310, “Revised WID: Enhanced Industrial Internet of Things (loT) and ultra-reliable and low latency communication (URLLC) support for NR,” Nokia, Nokia Shanghai Bell, RAN#88e

[11] 3GPP document R1-2007354, “Feature lead summary #4 on HARQ-ACK feedback enhancements for NR Rel-17 URLLC/IloT (AI 8.3.1.1),” Moderator (Nokia), RAN1#102-e

[12] 3GPP document R1-2005570, “Considerations on CSI feedback enhancements,” Sony, RAN1#102e

[13] 3GPP document R1-2005244, “CSI feedback enhancements,” Huawei, HiSilicon, RAN1#102e

[14] EP application 19183677.4 filed 1 Jul. 2019

1. A method for communicating in a mobile communications network, the network comprising a network equipment configured to provide a wireless interface to communicate with at least a terminal, the method comprising:
receiving, at the terminal, a grant message scheduling a plurality of downlink resource sets, wherein each of the plurality of downlink resource sets is for transmitting a corresponding one of a plurality of repetitions of a downlink data transmission,
wherein the grant message further comprises a request for a radio conditions report from the terminal and schedules an intermediate uplink resource set for transmitting the radio conditions report;
determining, based on the grant message, that intermediate acknowledgement feedback is to be notified to the base station;
making an intermediate attempt to decode the downlink data transmission based on a subset of the plurality of repetitions of the downlink data transmission; and
transmitting, using the intermediate uplink resource set, an indication of the intermediate acknowledgement feedback corresponding to the intermediate attempt to decode the downlink data transmission.

2. The method of claim 1 wherein the method further comprises, if the intermediate attempt is successful, transmitting an indication of a positive intermediate acknowledgement feedback message and stopping further attempts to decode the downlink data transmission.

3. The method of claim 1 , wherein the method further comprises, if the intermediate attempt is successful, transmitting no further acknowledgement feedback messages for the downlink data transmission.

4. The method of claim 1, wherein transmitting further comprises transmitting a radio conditions report in response to the request.

5. The method of claim 1, wherein
if the intermediate attempt is successful, not transmitting in the intermediate uplink resource set thereby providing a notification of a successful intermediate attempt;
if the intermediate attempt is unsuccessful, transmitting the radio conditions report in the intermediate uplink resource set, thereby providing a notification of a successful intermediate attempt.

6. The method of claim 1, wherein the grant message schedules a second uplink resource set for transmitting a final acknowledgement feedback message for the downlink data transmission using the plurality of repetitions and wherein the method further comprises transmitting, using the second uplink resource set, the final acknowledgement feedback message for the downlink data transmission.

7. The method of claim 6, wherein if the intermediate attempt is successful:
if it is determined that the second uplink resource set is also for transmitting another acknowledgement feedback message, wherein the other acknowledgement feedback message is for another downlink data transmission, transmitting the final acknowledgement feedback message and the other acknowledgement feedback message, using the second uplink resource set;
if it is determined that the second uplink resource set is not to be used for transmitting another acknowledgement feedback message, not transmitting the final acknowledgement feedback message in the second uplink resource set.

8. The method of claim 1, further comprising:
if the intermediate attempt is successful, transmitting, an intermediate acknowledgement feedback message in the intermediate uplink resource set;
if the intermediate attempt is unsuccessful, transmitting, the radio conditions report in the intermediate uplink resource set without an explicit intermediate acknowledgement feedback message for the unsuccessful intermediate attempt.

9. The method of claim 1, wherein determining, based on the grant message, that intermediate acknowledgement feedback is to be notified to the base station comprises:
identifying whether the grant message comprises a request for a radio conditions report;
if the grant message comprises a request for a radio conditions report, determining that intermediate acknowledgement feedback is to be notified to the base station using the intermediate uplink resource set;

10. The method of claim 9 wherein determining, based on the grant message, that intermediate acknowledgement feedback is to be notified to the base station further comprises
if the grant message does not comprise a request for a radio conditions report, determining that no intermediate acknowledgement feedback is to be notified using the intermediate uplink resource set.

11. The method of claim 1, wherein the intermediate uplink resource set is before the end of the plurality of the downlink resource sets.

12. The method of claim 1, wherein the grant message comprises location information for identifying the location of the uplink resource set, the location information comprising one or more of:
a number K_{1′} of time units after a reference time unit, wherein the uplink resource set is provided in the K_{1′}^{th} time unit after the reference time unit;
a number m of repetitions wherein the m^{th} repetition of the downlink data transmission identifies a reference time unit for identifying the location of the uplink resource set;
a number N of time units, wherein the N^{th} time unit is identified as a reference time unit for identifying the location of the uplink resource set;
a Physical Resource Indicator “PRI” indicating one or more of: a frequency resource, a duration and a starting symbol for identifying the location of the uplink resource set; and
a Time Domain Resource Indicator comprising one or both of: an uplink resource set start time, an uplink resource set start time as a symbol offset from a start time of a time unit, a duration of the uplink resource set and a duration of the uplink resource as a number of symbol from an uplink resource set start time.

13. A method for communicating in a mobile communications network, the network comprising a network equipment configured to provide a wireless interface to communicate with at least a terminal, the method comprising:
transmitting, at the network equipment, a grant message scheduling a plurality of downlink resource sets, wherein each of the plurality of downlink resource sets is for transmitting a corresponding one of a plurality of repetitions of a downlink data transmission and wherein the grant further comprises a request for a radio conditions report from the terminal, the grant message scheduling an intermediate uplink resource set for transmitting the radio conditions report; and
receiving, using the intermediate uplink resource set, an intermediate acknowledgement feedback notification based on an intermediate attempt to decode the downlink data transmission based on a subset of the plurality of repetitions of the downlink data transmission.

14. The method of claim 13, further comprising: if the intermediate acknowledgement feedback message indicates a successful intermediate attempt, stopping the transmission of the plurality of repetitions of the downlink data transmission.

15. The method of claim 13, further comprising: if the intermediate acknowledgement feedback message indicates an unsuccessful intermediate attempt, continuing the transmission of the plurality of repetitions of the downlink data transmission.

16. The method of claim 13, further comprising receiving, using the intermediate uplink resource set a radio conditions report in response to the request.

17. A terminal for use in a mobile communications network, the network comprising a network equipment configured to provide a wireless interface to communicate with at least the terminal, the terminal being configured to:
receive a grant message scheduling a plurality of downlink resource sets, wherein each of the plurality of downlink resource sets is for transmitting a corresponding one of a plurality of repetitions of a downlink data transmission,
wherein the grant message further comprises a request for a radio conditions report from the terminal and schedules an intermediate uplink resource set for transmitting the radio conditions report;
determine, based on the grant message, that intermediate acknowledgement feedback is to be notified to the base station;
make an intermediate attempt to decode the downlink data transmission based on a subset of the plurality of repetitions of the downlink data transmission; and
transmit, using the intermediate uplink resource set, an indication of the intermediate acknowledgement feedback corresponding to the intermediate attempt to decode the downlink data transmission.

18.-22. (canceled)
